(19) United States
(12) Patent Application Publication
(10) Pub. No.: US 2012/0207976 A1
(43) Pub. Date: Aug. 16, 2012

(54) POLARIZING PLATE AND LIQUID CRYSTAL DISPLAY EMPLOYING THE SAME

(75) Inventor: Takahiro TAKAGI, Kanagawa (JP)

(73) Assignee: KONICA MINOLTA ADVANCED LAYERS, INC., Tokyo (JP)

(21) Appl. No.: 13/454,880

(22) Filed: Apr. 24, 2012

Related U.S. Application Data
(63) Continuation-in-part of application No. PCT/JP2010/068142, filed on Oct. 15, 2010.

(30) Foreign Application Priority Data
Oct. 27, 2009 (JP) JP2009-246312

(51) Int. Cl. B32B 23/08

(52) U.S. Cl. 428/141

(57) ABSTRACT

A polarizing plate, includes: a hard coat film; a protective film; and a polarizer sandwiched between the hard coat film and the protective film, wherein the hard coat film includes a first cellulose ester film being contact with the polarizer, and a hard coat layer provided on the first cellulose ester film, wherein the hard coat layer includes a composition containing a curable resin and at least one thermoplastic resin selected from a group of a thermoplastic polyester resin, a thermoplastic polyester urethane resin, and an acrylic resin not having an ethylenically-unsaturated double bond, and wherein the hard coat layer is a cured layer of the composition, and has 500 to 200,000 protrusions per mm² on a surface thereof.

This application is a Continuation-in-Part Application of International Application PCT/JP2010/068142 filed on Oct. 15, 2010 in Japanese Patent Office, which is incorporated herein by this reference in its entirety.

### TECHNICAL FIELD

The present invention relates to a polarizing plate which aims to ensure compatibility between suppression of the occurrence of partial deformation failure and visibility (clearness) under the condition of high temperature and high humidity, and to a liquid crystal display employing the polarizing plate.

### BACKGROUND ART

Generally, on a liquid crystal cell which constitutes a liquid crystal display panel of a liquid crystal display (LCD), two polarizing plates are pasted. Such a polarizing plate includes a polarizer (polarizing film) in which a polyvinyl alcohol (hereafter, abbreviated as “PVA”) film is dyed with iodine or dichromatic dye and is stretched and oriented in a given direction, and the polarizing plate is fabricated in a three-layer structure in which the polyvinyl alcohol film is sandwiched between two cellulose ester protective films. Further, in order to paste the polarizing plate onto the substrate of the liquid crystal cell, an adhesive layer is provided on one side surface of a cellulose ester protective film.

A protective film disposed at the uppermost surface of a polarizing plate for use in a liquid crystal cell tends to be easily injured physically, and the injured protective film spoils the quality of a displayed image. Accordingly, a hard coat film in which a hard coat layer is disposed on a cellulose-based protective film is employed at the uppermost surface of a polarizing plate.

Further, in recent years, as such a hard coat film, from the viewpoint of higher contrast and visibility (clearness), rather than an anti-glare type film treated to obscure the contour of an image reflected to a surface, a clear type film is employed.

Meanwhile, as the application of liquid crystal displays spreads increasingly, the durability of a liquid crystal display panel is requested. That is, liquid crystal display panel is required to be stored or used for a long time under the severe environment of high temperature and humidity.

In the case where polarizing plates each provided with an adhesive layer for a liquid crystal display panel are stored on a stacked state for a long time under high temperature and high humidity on the assumption of transportation, modification failure is likely to take place partially on the uppermost surface of the polarizing plates due to blocking and the like, which is a problem in terms of quality.

A technique to improve the durability of polarizing plates under the condition of high temperature and high humidity is disclosed, for example, in Patent Document 1. According to this technique, a polarizing film being a hydrophilic polymer film is treated with an acidic solution, and a layer of a cured polymerizable resin composition is provided on a protective film, thereby improving the durability of a polarizing plate. However, with this technique, although the discoloration of a polarizing plate is improved to some extent, the occurrence of deformation failure, which is the problem of the present invention, may not be prevented.

Patent Document 2 discloses a technique to prevent blocking of a hard coat film with a hard coat layer formed with a coating layer composition which contains one or more organic ingredients, inorganic microscopic particles, and inorganic and/or organic particles with a primary particle size larger than that of the inorganic microscopic particles. However, addition of fine particles for the purpose of preventing blocking sufficiently allows haze to tend to rise. Accordingly, there still exists a problem in ensuring compatibility between suppression of the occurrence of partial deformation failure and visibility (clearness) which is the problem of the present invention.

Patent Document 3 discloses a technique to paste a protective film (first) on one surface of a polarizer and then, to paste a protective film (second) with a water vapor permeability higher than that of the protective film (first) on another surface of the polarizer in order to prevent blocking. However, the introduction of such a film with high water vapor permeability increases a water content and decreases film elastic modulus. As a result, problems arise in that wrinkles occur and the occurrence of deformation failure is not prevented.

### RELATED-ART DOCUMENT

### Patent Document

Patent document 1: Japanese Unexamined Patent Publication No. 2008-70571, official report

Patent document 2: Japanese Unexamined Patent Publication No. 2001-13303, official report

Patent document 3: Japanese Unexamined Patent Publication No. 2005-309394, official report

### SUMMARY OF INVENTION

### Problems to be Solved by the Invention

The present invention has been achieved in the light of the above problems and situations, the problems to be solved is to provide a polarizing plate which attains to ensure compatibility between suppression of the occurrence of partial deformation failure and visibility (clearness) under the condition of high temperature and high humidity, and to a liquid crystal display employing the polarizing plate.

### Structures for Solving the Problems

As a result of earnest studies for the above problems, the inventor found the following facts. By addition of at least one selected from thermoplastic polyester resin, thermoplastic polyester urethane resin, and acrylic resin not having an ethylenic unsaturated double bond according to present invention into a hard coat layer of a hard coat film to be pasted on a polarizing plate, it becomes possible to control the configuration of a protrusion and the number of protrusions in the hard coat layer. By provision of protrusions with a specific range in the hard coat layer so as to control the haze value of the hard coat film, it becomes possible to disperse stress applied to respective polarizing plates at the time of store of the polarizing plates on a stacked state. In addition, by use of protective films, different in water vapor permeability, disposed across a polarizer and by adjustment of a ratio of an elastic modulus in a conveyance direction (MD) and an elastic modulus in a width direction (TD) of the protective film with the higher water vapor permeability, it becomes possible to prevent partial deformation failure caused by decrease of elastic modulus due to store under the condition of high temperature and high humidity, and it becomes possible not to spoil clearness even if the hard coat film according to the present invention is used as a film located the uppermost surface of a liquid crystal display. As a result, it turns out that it becomes possible to ensure compatibility between suppression of the occurrence of partial deformation failure and visibility (clearness) under the condition of high temperature and high humidity, and the present invention is attained.

That is, the above-mentioned problems concerning the present invention is solved by the following structures.
Item 1 A polarizing plate, includes:

a hard coat film;

a protective film;

a polarizer sandwiched between the hard coat film and the protective film,

wherein the hard coat film includes a first cellulose ester film being contact with the polarizer, and a hard coat layer provided on the first cellulose ester film,

wherein the hard coat layer includes a composition containing a curable resin and at least one thermoplastic resin selected from a group of a thermoplastic polyester resin, a thermoplastic polyester urethane resin, and an acrylic resin not having an ethylenically-unsaturated double bond, and

wherein the hard coat layer is a cured layer of the composition, and has 500 to 200,000 protrusions per mm² on a surface thereof.
Item 2 In Item 1, the curable resin is an actinic ray curable resin.
Item 3 In Item 1, a ratio by weight between the curable resin and the thermoplastic resin is in a range of (100:0.01) to (100:10).
Item 4 In Item 1, each of the protrusions has a height of 1 nm to 5 μm.
Item 5 In Item 1, the hard coat layer has an arithmetic average roughness Ra of 3 to 20 nm according to JIS B0601: 2001.
Item 6 In Item 1, the hard coat layer has a pencil hardness of 1 H or more.
Item 7 In Item 1, the first cellulose ester film has a degree of substitution of 2.8 to 3.0 with an acetyl group.
Item 8 In Item 1, the hard coat layer includes a plurality of layers, and an uppermost layer of the plurality of layers is the cured layer of the composition containing the thermoplastic resin and the curable resin.
Item 9 In Item 8, the uppermost layer has a thickness of 0.05 to 2 μm.
Item 10 In Item 1, the protective film includes a second cellulose ester film, and the second cellulose ester film has a retardation value Ro represented by Formula (I) in a range of 40 to 100 nm, and a retardation value Rth represented by Formula (II) in a range of 90 to 300 nm,

Ro=(nx−ny)×d Formula (I):

Rth={(nx+ny)/2−nz}×d Formula (II):

in the formulas, nx represents a refractive index in an in-plane slow axis direction of the film, ny represents a refractive index in an in-plane fast axis direction of the film, nz represents a refractive index in a thickness direction of the film, and d is a thickness (nm) of the film.
Item 11 In Item 1, the second cellulose ester film has a water vapor permeability in a range of 1000 to 1,500 g/m²•day.
Item 12 In Item 1, n the second cellulose ester film has a ratio of elastic modulus (MD) to elastic modulus (ID) which satisfies Formula (III).

0.75≦MD/TD≦1.3 Formula (III):

where MD represents elastic modulus in a conveyance direction, and TD represents elastic modulus in a direction perpendicular to the conveyance direction.
Item 13 In Item 1, the second cellulose ester film has a degree of substitution of 2.0 to 2.6 with an acetyl group.
Item 14 In Item 1, the second cellulose ester film contains an ester compound which includes 1 to 12 pieces of at least one of a pyranose structure or a furanose structure in which all or a part of hydroxyl groups are esterified.

### Effect of the Invention

According to the above structure of the present invention, it becomes possible to provide a polarizing plate which attains to ensure compatibility between suppression of the occurrence of partial deformation failure and visibility (clearness) under the condition of high temperature and high humidity, and a liquid crystal display employing the polarizing plate.

### BRIEF DESCRIPTION OF THE DRAWINGS

FIG. 1 is a cross section observation view of protrusion configuration included in a hard coat layer by observation via a transmission electron microscope.

FIG. 2 is a schematic diagram of a hard coat film having a hard coat layer and a polarizing plate.

FIG. 3 is a conceptual diagram showing a method of an endurance test for a polarizing plate.

### EXPLANATION OF REFERENCE SYMBOLS

1 Substrate film
2a and 2b Hard coat layer
3 Polarizing film
4 Protection film
5 Adhesive Layer
6 Hard coat film
7 Polarizing plate
8 Glass plate

### EMBODIMENT FOR CARRYING OUT THE INVENTION

Hereafter, explanation will be made in detail for the present invention, the structural elements of the present invention, and embodiments for carrying out the present invention.

### <The Number of Protrusions, and the Configuration of Protrusions>

The hard coat layer according to the present invention is characterized by having the number of protrusions in a range of 500 200000 pieces/mm². In this connection, the number of existing protrusions is a value measured by the following procedures.

Further, in the case where a polarizing plate is used in display devices such as liquid crystal displays, the above-mentioned number of protrusions may be measured also from the hard coat layer arranged at the viewing side.

In the measurement of the number of protrusions, a hard coat layer is measured by an optical interference type surface roughness meter (RST/PLUS, manufactured by WYKO Corporation, with a magnification of 50 times). Next, the number of protrusions in the measured area (100 μm×100 μm in square) is read out from the measured image. This series of measurement operations is conducted by ten times so as to obtain ten measurement values. Then, the number of protrusions on the hard coat layer of the hard coat film is determined from the average value of the ten measurement values.

As the number of protrusions, protrusions with a height of 3 nm or more from the mean line of a roughness curve are counted.

In the size of the configuration of a protrusion, the height is 1 nm to 5 μm, preferably 1 nm to 1 μm, and more preferably 10 nm to 0.5 μm. The width is 50 nm to 100 μm, and preferably 50 nm-50 μm.

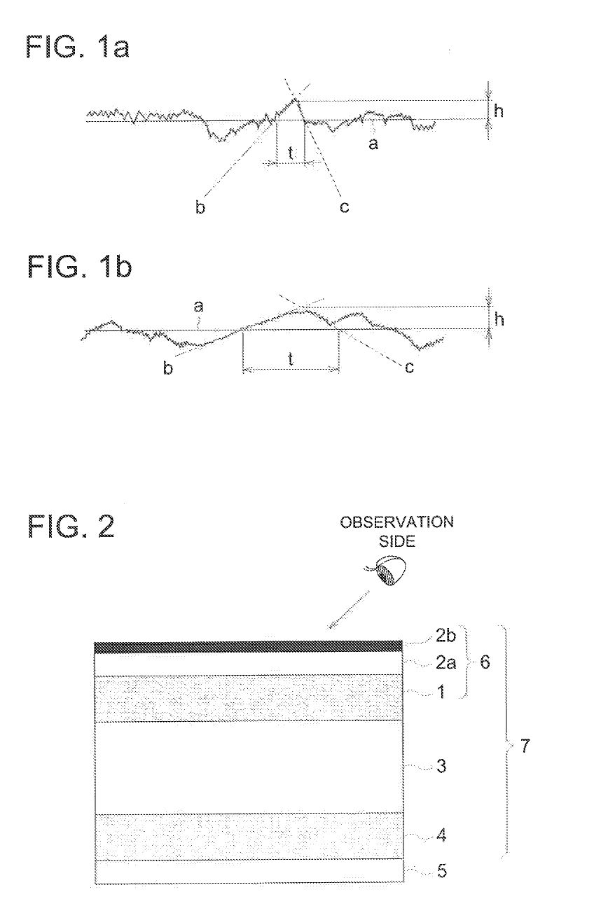

The above-mentioned width and height of the configuration of a protrusion can be determined from the cross-section observation mentioned below. FIG. 1 is a drawing for explaining protrusions. A hard coat film is cut out in the width direction of the film at an angle of 0° under a mom temperature by use of a microtome (manufactured by NIPPON MICROTOME KENKYUSHO KK, thereby obtaining a cross section. Next, the resulting cross section is observed by use of a transmission electron microscope (TEM, with a magnification of 2000 times). In the image in the cross section observation, as shown in the drawing, in accordance with the definition in JIS B 0601: 2001, a center line “a” is drawn in the image. Successively, two lines “b” and “c” are drawn to form a foot of a mountain (protrusion), thereby obtaining two intersections between the line “b” and the center line “a” and between the line “c” and the center line “a”. Then, the distance between the two intersections is set to a width “t” in the size of the protrusion. Further, the distance between the top of the mountain (protrusion) and the center line “a” is determined as a height “h” in the size of the protrusion.

The arithmetic mean roughness Ra, specified in JIS B0601: 2001, of a hard coat layer according to the present invention is preferably 2 to 20 nm, and more preferably 3 to 20 nm. The roughness in the above range ensures excellent visibility (clearness) and good effects to suppress the occurrence of partial deformation failure after an endurance test.

The arithmetic mean roughness of a hard coat layer can be determined via measurement and analysis by use of a commercially-available surface roughness measuring instrument. In the present invention, the roughness is determined by use of a small-size surface roughness measuring instrument (model number: SJ-401, manufactured by Mitutoyo Corporation). Further, the roughness may be measured by an optical interferotype surface roughness measuring instrument, such as a non-contact surface microscopic profile measuring instrument WYKO NT-2000 manufactured by WYKO Co., Ltd.

### <Elastic Modulus>

In the present invention, the second cellulose ester film is characterized in that a ratio of a conveyance-direction elastic modulus in a conveyance direction and a perpendicular-direction elastic modulus in a direction perpendicular to the conveyance direction satisfies the following Formula (III). Formula (III):

0.75≦Conveyance-direction elastic modulus (MD)/Perpendicular-direction elastic modulus (TD)≦1.3

In the present invention, elastic modulus is measured under the environment of 25° C. and 60% RH in accordance with the method specified in JIS K7127 by use of a tensile testing instrument (Tensilon, manufactured by ORIENTEC Co., Ltd.). At the time of measurement, a test piece (sample) has a size of 100 mm×10 mm and is subjected to humidity control for 24 hours under the environment of 25° C. and 60% RH. The measurement is conducted on a condition that a distance between chucks is 50 mm and a test speed is 100 mm/minute.

In the present invention, the adjustment to make the ratio of elastic modulus in a range defined by Formula (III) is implemented by the condition control of an stretching operation for cellulose ester film.

### <Thermoplastic Resin>

The hard coat layer according to the present invention is characterized by having protrusions as mentioned above and by containing at least one thermoplastic resin selected from thermoplastic polyester resin, thermoplastic polyester urethane resin, and acrylic resin which does not have an ethylenic unsaturated double bond.

The above-mentioned resin is easily oriented on a surface, and when the resin is mixed with a binder component in a hard coat layer mentioned later, the resin tends to separate from the phase of the binder component. Accordingly, it is presumed that the microscopic configuration of a protrusion excellent in productivity and reproducibility can be obtained on the surface of a hard coat layer.

With adjustment of an addition amount of the above-mentioned resin or selection of the binder component in a hard coat layer mentioned later, the number of protrusions can be controlled in the above range.

The above method for disposing protrusion configurations may be employed in combination with other methods, such as a method for adding fine particles, a method of forming protrusions on a surface by pressing with a molding die, or a method for forming surface convexo-concave unevenness by mixing resins different in SP value (solubility parameter) (for example, methods described in Japanese Unexamined Patent Publication Nos. 2007-182519 and 2009-13384)

As molding rolls used for forming protrusions, a molding roll with a mold pattern appropriately selected from patterns of from a fine convexo-concave pattern to a coarse convexo-concave pattern may be employed. Examples of the patterns include a design pattern, a matting pattern, a lenticular lens patter, and a pattern in which spherical convexo-concave protrusions are regularly or randomly arranged.

These resins may be used independently or may be uses in combination of two or more kinds.

First of all, a thermoplastic polyester resin will be explained. Examples of the polyester resin include polymers obtained by condensation polymerization of at least one of alcohol components and at least one of carboxylic acid components. Examples of the alcohol components include ethylene glycol, propylene glycol, 1,3-butanediol, 1,4-butanediol, diethylene glycol, triethylene glycol, 1,5-pentanediol, 1,6-hexanediol, neopentylglycol, cyclohexane-1,4-dimethanol, hydrogenated bisphenol A, an ethylene oxide or propylene oxide adduct of bisphenol A. Examples of the carboxylic acid components include terephthalic acid, isophthalic acid, naphthalene dicarboxylic acid, cyclohexane-1,4-dicarboxylic acid, adipic acid, azelaic acid, maleic acid, fumaric acid, itaconic acid, and an acid anhydride of them. Next, a thermoplastic polyester urethane resin will be explained. Examples of the thermoplastic polyester urethane resin include polymers obtained by making polyester polyol, which was obtained by condensation polymerization of the above alcohol components and carboxylic acid components and has a hydroxyl group at its terminal, to react with at least one of various poly isocyanate compounds. Examples of the commercially-available products of the polyester resin and the polyester urethane resin include VYLON Series (Trade name): manufactured by Toyobo Co., Ltd.

Acrylic resin which does not have an ethylenically unsaturated double bond will be explained. Examples of the acrylic resin include a polymer of at least one monomer selected from (meth)acrylic acid alkyl esters with an alkyl having 1 to 20 carbon atoms and a copolymer of the (meth)acrylic acid alkyl ester and the other co-polymerizable monomer. Further, examples of a carboxyl group-containing acrylic resin include the resin synthesized by the method described in Japanese Unexamined Patent Publication No. 8-193101. Specifically, such a resin can be obtained as a copolymer by partial neutralization between monoethylenically unsaturated dicarboxylic acid and acrylic acid and/or methacrylic acid.

Examples of the above-mentioned monoethylenically unsaturated dicarboxylic acid include maleic acid, itaconic acid, mesaconic acid, fumaric acid, methylenemalonic acid, citraconic acid, a maleic acid anhydride. Further, examples of the commercially-available products of the acrylic resin include ARUFON-UP 1000 Series, UH2000 Series, and UC3000 Series (Trade Name): manufactured by Toagosei Chemistry Co., Ltd.

In the case where the above three kinds of resins are collectively indicated, they are described as thermoplastic resin.

An actinic ray curable resin mentioned later and the above-mentioned thermoplastic resin may be contained in a hard coat layer preferably with a content ratio of the actinic ray curable resin and the above-mentioned resin being (100:0.01) to (100:10) in weight basis. The employment of the thermoplastic resin in the above range ensures that protrusions are formed in good configuration in a hard coat layer and the hard coat layer becomes excellent in clearness and has a good hardness (abrasion resistant).

### <Haze>

The hard coat film according to the present invention is used with a haze value in a range of 0.2 to 0.7%. The haze value made in a range of 0.2 to 0.7% in the hard coat film not only achieves the object and effect of the present invention, but also is preferable in acquiring sufficient brightness and high contrast at the time of use of the hard coat film in a large-sized liquid crystal display apparatus or at outdoor applications such as digital signage. On the other hand, if the haze value of a hard coat film is less than 0.2, a design may be actually difficult in terms of easiness in handling of the hard coat film.

The haze value of a hard coat film can be adjusted within the above range by use of a substrate film with a proper haze value (0.1 to 0.5%) and by adjustment of a content ratio of the resin constituting a hard coat layer coated on the substrate film and a binder component in the hard coat layer. Further, since a surface roughness influences the haze value as a factor of a surface haze, it is effective to control the configuration of protrusions and the number of protrusions.

### <Hard Coat Film>

The hard coat film according to the present invention includes a hard coat layer on at least one side the first cellulose ester film (substrate film). That is, the hard coat film is composed of at least the substrate film and the hand coat layer, and the hard coat layer includes a binder component. As the binder component, an actinic ray curable resin is desirably employed.

Here, an “actinic ray curable resin” means a resin which includes as a main component a resin capable of curing or hardening through a crosslinking reaction by irradiation of actinic rays (also referred to as “activity energy ray”.) such as ultraviolet rays and electron rays.

### (Actinic Ray Curable Resin)

As the actinic ray curable resin, a resin component including a monomer having an ethylenically-unsaturated double bond may be preferably used. Such a resin component cures by being irradiated with actinic rays such as ultraviolet rays and electron rays so as to form an actinic ray cured resin layer. Although typical examples of the actinic ray curable resin include ultraviolet ray curable resins and electron ray curable resins, resins capable of curing by irradiation of ultraviolet rays are preferable because of excellence in mechanical film strength (abrasion resistance, pencil hardness). Examples of the ultraviolet ray curable resins include ultraviolet ray curable polyester acrylate resins, ultraviolet ray curable epoxy acrylate resins, ultraviolet ray curable polyol acrylate resins, and ultraviolet ray curable epoxy resins. Among them, ultraviolet ray curable acrylate resins may be preferable. As the ultraviolet ray curable acrylate resins, multifunctional acrylates are desirable. The multifunctional acrylate is preferably selected from a group consisting of pentaerythritol multifunctional acrylate, dipenta erythritol multifunctional acrylate, pentaerythritol multifunctional methacrylate, and dipenta erythritol multifunctional methacrylate. Here, the multifunctional acrylate is a compound which has two or more acryloyl oxy groups or (meth)acryloyl oxy groups in a molecule. Examples of the monomers of the multifunctional acrylate include ethylene glycol diacrylate, diethylene glycol diacrylate, 1,6-hexanediol diacrylate, neopentylglycol diacrylate, trimethylolpropane triacrylate, trimethylolethane triacrylate, tetramethylolmethane triacrylate, tetramethylolmethane tetraacrylate, pentaglycerol triacrylate, pentaerythritol diacrylate, pentaerythritol triacrylate, pentaerythritol tetraacrylate, glycerol triacrylate, dipentaerythritol triacrylate, dipentaerythritol tetraacrylate, dipentaerythritol pentaacrylate, dipentaerythritol hexaacrylate, tris(acryloyl oxyethyl)isocyanurate, ethylene glycol dimethacrylate, diethylene glycol dimethacrylate, 1,6-hexanediol dimethacrylate, neopentylglycol dimethacrylate, trimethylolpropane trimethacrylate, trimethylolethane trimethacrylate, tetramethylolmethane trimethacrylate, tetramethylolmethanetetra methacrylate, pentaglycerol trimethacrylate, pentaerythritol dimethacrylate, pentaerythritol trimethacrylate, pentaerythritol tetramethacrylate, glycerol trimethacrylate, dipentaerythritol trimethacrylate, dipentaerythritol tetramethacrylate, dipentaerythritol pentamethacrylate, dipentaerythritol hexamethacrylate, and isobomyl acrylate. The above compounds may be used solely, or in combination of two or more kinds as a mixture. Further, an oligomer such as a dimer or a timer of the above monomer may be also employed.

Further, the hard coat layer may contain a photopolymerization initiator in order to accelerate curing of the actinic my curable resin. The photopolymerization initiator may be contained preferably with a weight ratio, (photopolymerization initiator : actinic ray curable resin=20:100 to 0.01:100).

Specific examples of the photopolymerization initiator, without being limited thereto, include acetophenone, benzophenone, hydroxybenzophenone, Michler's ketone, α-amyloxim ester, thio xanthone, and derivatives of them.

### (Solvent)

As a solvent in a coating composition at the time of formation of a hard coat film by coating, it is preferable to use a mixture solvent of a good solvent for a thermoplastic resin and a poor solvent for the thermoplastic resin. Here, the good solvent and the poor solvent refer is defined by the solubility of a solvent measured by the following method.

That is, when a solvent subjected to measurement of solubility is added to the thermoplastic resin with the equivalent of the solid component of 3 g so as to make the total weight to 20 g, and mixed at 25° C., if the resulting mixture solution has uniform transparency, no change in viscosity, and compatibility, the solvent is judged as a good solvent for the sample of the thermoplastic resin. In contrast, if any one of muddy, viscosity increase, and separation is observed, the solvent is judged as a poor solvent for the sample of the thermoplastic resin.

In the case where the thermoplastic resin is, for example, a polyester resin or a polyester urethane resin, examples of the good solvent, include toluene, methyl ethyl ketone, methyl isobutyl ketone, cyclohexanone, acetone, ethyl acetate, tetrahydrofuran and the like. Meanwhile, examples of the poor solvent include xylene, ethyl cellosolve, propylene glycol monomethyl ether, isobutanol, isopropanol, ethanol, methanol, hexane, purified water, and the like. Further, in the case where the thermoplastic resin is an acrylic resin, examples of a good solvent include toluene, methyl ethyl ketone, methyl isobutyl ketone, cyclohexanone, acetone, ethyl acetate, tetrahydrofuran, xylene, and the like. Meanwhile, examples of the poor solvent include ethyl cellosolve, propylene glycol monomethyl ether, isobutanol, isopropanol, ethanol, methanol, hexane, purified water, and the like. Incidentally, any one of the poor solvents except the above good solvent and the purified water is a good solvent for a usually-employed actinic ray curable resin.

In the present invention, each of the good solvent and the poor solvent may be used solely or in combination of two or more kinds for the thermoplastic resin.

Moreover, the hard coat layer according to the present invention may contain particles of an inorganic compound or an organic compound.

### (Particles)

Examples of inorganic particles include silicon oxide, titanium oxide, aluminium oxide, tin oxide, indium oxide, no, zinc oxide, zirconium oxide, magnesium oxide, calcium carbonate, talc, clay, calcined kaolin, calcined calcium silicate, hydrated calcium silicate, aluminium silicate, magnesium silicate, calcium phosphate, and the like. Specifically, silicon oxide, titanium oxide, aluminium oxide, zirconium oxide, magnesium oxide and the like are used preferably.

In order to improve abrasion resistance while maintain the transparency of a hard coat film, at least a part of the surface of each of these inorganic particles may be preferably covered with an organic component having a reactive functional group. A part of the surface of inorganic particles may be covered with an organic component having a reactive functional group by at least the following methods. In the first method, a compound containing an organic component such as a silane coupling agent is made to react with hydroxyl groups existing on the surface of each metal oxide particles so as that the organic component bonds on a part of the surface. In the second method, an organic component is made to adhere by relative action such as hydrogen bond to hydroxyl groups existing on the surface of each metal oxide particles. In the third method, one polymer or two or more inorganic particles may be contained in a polymer particle.

As the organic paticles, moreover, added may be polymethacrylate methyl acrylate resin powder, acrylic styrene resin powder, polymethyl methacrylate resin powder, silicon resin powder, polystyrene resin powder, polycarbonate resin powder, benzoguanamine resin powder, melamine resin powder, polyolefin resin powder, polyester resin powder, polyamide resin powder, polyimide resin powder, polyfiuomethylene resin powder and the like.

Preferable examples of particles include cross-linked polystyrene particles (for example, SX-130H, SX-200H, SX-350H: manufactured by Soken Chemical & Engineering Co., Ltd), polymethylmethacrylate particles (for example, MX150, MX300: manufactured by Soken Chemical & Engineering Co., Ltd), and a fluorine-containing acrylic resin particles. Examples of the fluorine-containing acrylic resin particles include commercially-available products of FS-701 and the like: manufactured by Nippon Paint Co., Ltd.

Although the average particle size of these particle powders is not limited specifically, the size is preferably 0.01 to 5 μm, and more preferably 0.01 to 1.0 μm. Further, two or more kinds of particles different in particle size may be contained. The average particle size of particle may be measured by, for example, a laser diffraction particle distribution measuring device.

With regard to a ratio of particles to ultraviolet ray curable resin composition, it is desirable to blend I to 400 parts by weight of particles to 100 pats by weight of resin composition, and more preferably 50 to 200 parts by weight of particles.

These hard coat layers can be formed such that a coating composition to form a hard coat is coated by methods with well-know coaters such as a gravure coater, a dip coater, a reverse coater, a wire burr coater, a die coater, and an ink-jet coater, and after the coating, the resultant coating layer is dried with heat and subjected to a UV curing process.

A coating amount is properly 0.1 to 40 μm as a wet film thickness, and preferably 0.5 to 30 μm. Further, an average film thickness as a dried film thickness is 0.1 to 30 μm, preferably 1 to 20 μm, and more preferably 6 to 15 μm.

As a light source for use in UV cure treatment, as long as light sources emit ultraviolet rays, any light source may be employed without limitation. For example, a low-pressure mercury lamp, a middle-pressure mercury lamp, a hyperbaric pressure mercury-vapor lamp, an high-pressure mercury lamp, a carbon arc lamp, a metal halide lamp, a xenon lamp, and the like can be used.

Although irradiation conditions may differ in respective lamps, the irradiation amount of actinic rays is 5 to 500 mJ/cm² usually, and 5 to 200 mJ/cm² preferably.

Moreover, it is preferable to irradiate actinic rays while applying tension in the conveyance direction of a film, and it is more preferable to irradiate actinic rays while applying tension in the width direction as well as in the conveyance direction of a film. The applied tension is preferably 30 to 300 N/m. The method of applying tension is not limited specifically. The tension may applied in the conveying direction on a back roll, and further, the tension may be applied in the width direction by tentar or in the biaxial direction. With this, a film more excellent in flatness can be obtained.

In order to provide antistatic property, a hard coat layer may contain a conductive agent Preferable examples of the conductive agent include metal oxide particles or π-conjugated conductive polymer. Further, an ionic liquid is also preferably used as a conductive compound.

Further, from the viewpoints of coating ability and uniform dispersion ability of particles, the hard coat layer may also contain nonionic surfactants, such as a silicone surface active agent, a fluorine surface active agent, and polyoxyether, an anionic surface active agent, and the like.

FIG. 2 shows a schematic diagram of a hard coat film with a hard coat layer according to the present invention, and a polarizing plate. In FIG. 2, although the hard coat layer is made in a two layer lamination structure such as hard coat layers 2a and 2b, the hard coat layer may be a single layer or multiple layers. In order to facilitate to control a hard coat nature, haze, configuration of protrusions formed on the surface, and a arithmetic surface roughness Ra, it is preferable to divide two or more layers. In the case of provision of two or more layers, the thickness of the uppermost layer is preferably in a range of 0.05 to 2 μm from the viewpoint of close contact ability with the lower layer. Further, the thickness of the lower layer may be preferably in a range of 5 to 14 μm. A lamination of two or more layers may be formed by simultaneous lamination. In the simultaneous lamination, hard coat layers of two or more layers are coated by wet-on-wet basis on a substrate without application of a drying process. In order to coat the second hard coat layer by wet-on-wet basis on the first hard coat layer without application of a dry process, the second hard coat layer may be coated or laminated sequentially by a extrusion coater, or laminated simultaneously by a slot die with a plurality of slots.

The hard coat film in the present invention has pencil hardness, as an index of hardness, of 1 H or more, and more preferably 2 H or more. With the pencil hardness of 2 H or more, a hard coat layer is not likely to be injured in the process of production of a polarizing plate of a liquid crystal display device. Not only the above, in addition, when the hard coat layer is used a large size liquid crystal display apparatus used in many cases for the outdoor application, or when the hard coat layer is used as a surface protective film of a liquid crystal display apparatus for use in digital signage, the hard coat layer exhibits excellent film strength. The pencil hardness is the value measured in accordance with the pencil hardness evaluation method specified in JISK5400 by use of a test pencil specified in MS S 6006 specifies, after a produced hard coat film is subjected to humidity control for 2 hours or more on the conditions of a temperature of 23° C. and a relative humidity of 55%.

### <First Cellulose Ester Film and Second Cellulose Ester Film>

The first cellulose ester film of the present invention is used as a substrate film, and the second cellulose ester film is used as a protective film. Preferable requirements of both films include easiness in production, good adhesiveness with a polarizer, and optically transparence.

The term “transparence” used in the present invention means that the transmittance of visible light is 60% or more, preferably 80% or more, and particularly preferably 90% or more.

Examples of cellulose ester as main components of the first cellulose ester film of the present invention and the second cellulose ester film of the present invention include cellulose acetate, cellulose acetate butyrate, and cellulose acetate propionate, and among them, a cellulose acetate is used preferably.

As the first cellulose ester film of the present invention, from the viewpoint of optical isotropy required for a polarizing plate protective film, film composed of cellulose ester in which X and Y exist in a rage represented by Formula (Ac1) where a degree of substitution by an acetyl group is X and a degree of substitution by an acyl group is X, is employed.

2.8≦X+≦3.0 Formula (Ac1)

That is, the first cellulose ester film is a film composed of cellulose ester with a total acyl group substitution degree of 2.8 or more and 3.0 or less.

The first cellulose ester film is composed of cellulose ester which satisfies 2.8≦X≦3.0, namely, preferably is a cellulose triacetate film.

Herein, in the present invention, in the case where the expression (cellulose ester film “is composed” of specific cellulose ester) is used, the expression means that the specific cellulose ester is made as a main component, that is, the cellulose ester film contains the specific cellulose ester in an amount exceeding 50% by weight. Accordingly, the specific cellulose ester may contain another resin in a range which does not spoil the function of the present invention, and may contain various kinds of additives in accordance with purposes.

As the second cellulose ester film relating to the present invention, from the viewpoints of high retardation exhibiting property, possibility to make a film thin even if being made to a retardation film having a high retardation, and enablement to suppress a stretching ratio, which exhibits retardation, to be low, film composed of cellulose ester which satisfied a range represented by the following Formula (Ac2) may be employed.

2.0≦X+Y≦2.6 Formula (Ac2)

That is, the second cellulose ester film is a film composed of cellulose ester with a total acyl group substitution degree of 2.0 or more and 2.6 or less,.

Preferably, cellulose ester satisfies 2.0≦X≦2.6. Further, total acyl group substitution degree (X+Y) is preferably 2.1≦X+Y<2.5, more preferably 2.2≦X+Y<2.5, and portions which are not substituted exist as a hydroxyl group.

In the second cellulose ester film relating to the present invention, although the needed retardation becomes different in accordance with the required optical compensation effect, from the viewpoints of utilization of the high retardation exhibiting property, an in-plane direction retardation Ro defined by the following formula is preferably in a range of 40 to 100 nm, and more preferably in a range of 40 to 80 nm, and a thickness direction retardation Rt is preferably in a range of 90 to 300 nm, and more preferably in a range of 90 to 250 nm.

Although a method for adjusting retardation is not limited specifically, an adjusting method with stretching treatment is common. The adjusting method will be mentioned later in detail.

The cellulose ester used for these first cellulose ester film and second cellulose ester film relating to the present inventions can be synthesized by well-known methods.

Cellulose as raw materials of cellulose ester utilized in a retardation film and a polarizing plate protective film relating to the present invention is not specifically limited, and includes such as cotton linter, wood pulp (obtained from acicular trees or from broad leaf trees) and kenaf. Further, cellulose ester prepared from them can be utilized by mixing each of them at an arbitrary ratio. Cellulose ester, in the case that an acylation agent as a cellulose starting material is acid anhydride (such as acetic anhydride, propionic anhydride, and butyric anhydride), is prepared by a reaction utilizing a proton type catalyst such as sulfuric acid in an organic acid such as acetic acid or in an organic solvent such as methylene chloride.

In the case that an acylation agent is acid chloride (CH₃COCl, C₂H₅COCl or C₃H₇COCl), the reaction is performed utilizing a basic compound such as amine as a catalyst. Specifically, the synthesis can be performed referring to a method described in JP-A H10-45804. The cellulose ester used in the present invention is obtained through a reaction using in combination of the above acylation agents depending on the acylation degree. In an acylation reaction to form a cellulose ester, an acyl group reacts with the hydroxyl group of a cellulose molecule. A cellulose molecule is made up of many glucose units connected each other, and a glucose unit contains three hydroxyl groups. The number of hydroxyl groups substituted by acyl groups in a glucose unit is referred to as a degree of acetyl substitution (in mol %). For example, in the case of cellulose triacetate, all the three hydroxyl groups in one glucose unit are substituted by acetyl groups (practically: 2.6 to 3.0).

Measurement of a degree of substitution of an acyl group can be performed based on ASTM-D817-96.

The number average molecular weight of cellulose ester is preferably 30,000-200,000, because a mechanical strength at the time of film formation becomes strong, and a dope solution becomes proper viscosity, and more preferably 30,000-150,000. Further, the ratio of weight average molecular weight (Mw)/number average molecular weight (Mn) is preferably in a range of 1.4 to 4.5.

Although the second cellulose ester film of the present invention is required to have Ro of 40 run or more and Rt of 90 nm or, there is no restraint in Ro and Rt for the first cellulose ester film. These Ro and Rt can be adjusted by the usual stretching treatment at the time of film production.

It is desirable that the second cellulose ester film relating to the present invention contains the following plasticizers particularly from the viewpoints of the dimensional stability in the environmental variation which causes the unevenness of a polarizing plate.

Examples of the plasticizers include phosphate ester plasticizers, phthalate ester plasticizes, trimellitate ester plasticizes, pyromellitate ester plasticizes, polyester plasticizers, and the like. Examples of phosphate ester plasticizers include triphenylphosphate, tricresyl phosphate, cresyl diphenyl phosphate, octyl diphenyl phosphate, diphenylbiphenyl phosphate, trioctyl phosphate, tributyl phosphate, and the like. Examples of phthalate ester plasticizes include diethyl phthalate, dimethoxyethyl phthalate, dimethyl phthalate, dioctyl phthalate, dibutyl phthalate, di-2-ethyl hexyl phthalate, butylbenzyl phthalate, diphenyl phthalate, dicyclohexyl phthalate, and the like. Examples of the trimellitate ester plasticizes include tributyl trimellitate, triphenyl trimellitate, methyl trimellitate, and the like. Examples of the pyromellitate ester plasticizes include tetrabutyl pyromellitate, tetraphenyl pyromellitate, tetraethyl pyromellitate, and the like. Examples of the glycolate plasticizers include triacetin, tributyrin, ethyl phthalyl ethyl glycolate, and the like. Examples of the citrate plasticizer include triethyl citrate, tri-n-butyl citrate, acetyl triethyl citrate, acetyl tri-n-butyl citrate, acetyl tri-n-(2-ethyl hexyl)citrate, and the like. Examples of the other carboxylate esters include trimethylolpropan tribenzoate, butyl oleate, methyl acetyl ricinolate, dibutyl sebacate, various trimellitate esters, and the like. Examples of the polyester plasticizers include copolymerization polymers of dibasic acids, such as aliphatic dibasic acid, alicyclic dibasic acid, and aromatic dibasic acid, and glycol.

Examples of the aliphatic dibasic acids include, without being limited thereto, adipic acid, sebacic acid, phthalic acid, terephthalic acid, 1,4-cyclohexyl dicarboxylic acid, and the like. Examples of the glycol include ethylene glycol, diethylene glycol, 1,3-propylene glycol, 1,2-propylene glycol, 1,4-butylene 1,3-butylene glycol, 1,2-butylene glycol, and the like.

These dibasic acids and glycols maybe used solely, or in combination of two or more kinds as a mixture.

The used amount of these plasticizers is, from the viewpoints of film performance and processability, 1% by weight to 20% by weight to the cellulose ester, and more preferably 3% by weight to 13% by weight.

The second cellulose ester film relating to the present invention preferably includes an ester compound which includes one or more and 12 or less of at least one kind of a furanose structure and a pyranose structure and in which all or a part of OH groups in its structure is esterified.

The ratio of esterification is preferably 70% or more of OH groups which exist in the pyranose structure or the furanose structure.

In the present invention, the ester compounds are collectively referred to as sugar ester compounds.

Examples of the ester compounds preferably used in the present invention include the following compounds. However, the present invention is not limited to these compounds.

Examples include glucose, galactose, mannose, fructose, xylose, or arabinose, lactose, sucrose, nystose, 1F-fructosylnystose, stachyose, maltitol, lactitol, lactulose, cellobiose, maltose, cellotriose, maltotriose, raffinose and kestose.

In addition, gentiobiose, gentiotriose, gentiotetraose, xylotriose, and galactosyl-sucrose may be employed.

Among these compounds, compounds having both of the furanose structure and the pyranose structure are preferable.

As examples of the compounds, sucrose, kestose, nystose, 1F-fructosylnystose, and stachyose may be preferable, in particular, sucrose may be more preferable.

Monocarboxylic acids to be used to esterify all or a part of OH groups of the pyranose structure or the furanose structure of the present invention, are not specifically limited, and known aliphatic monocarboxylic acids, alicyclic monocarboxylic acids and aromatic monocarboxylic acids may be used. These monocarboxylic acids may be used singly or in combination of two or more kinds.

Examples of preferable aliphatic monocarboxylic acid include a saturated fatty acid such as acetic acid, propionic acid, butylic acid, isobutylic acid, valerianic acid, capronic acid, enanthic acid, caprylic acid, pelargonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanic acid, arachidic acid, behenic acid, lignoceric acid, cerotic acid, heptacosanoic acid, montanic acid and melissic acid, and a unsaturated fatty acid such as undecylic acid, oleic acid, sorbic acid, linolic acid, linolenic acid, arachidonic acid and octenic acid.

Examples of preferable alicyclic monocarboxylic acid, include acetic acid, cyclopentane carboxylic acid, cyclohexane carboxylic acid, cyclo octane carboxylic acid, and derivatives of them.

Examples of preferable aromatic monocarboxylic acid include benzoic acid, an aromatic monocarboxylic acid formed by introducing one to five alkyl or alkoxy groups into the benzene ring of benzoic acid such as toluic acid, an aromatic monocarboxylic acid having two or more benzene rings such as cinnamic acid, benzilic acid, biphenyl carboxylic acid, naphthalene carboxylic acid, tetralin carboxylic acid and derivatives thereof More concretely, xylic acid, hemellitic acid, mesitylenic acid, prehnitylic acid, γ-isodurylic acid, isodurylic acid, mesitoic acid, α-isodurylic acid, cuminic acid, α-toluic acid, hydratropic acid, atropic acid, cinnamic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-vcratric acid, gallic acid, asaronic acid, mandelic acid, homoanisic acid, Homovanillic acid, homoveratric acid, o-homoveratric acid, phthalonic acid, p-coumaric acid. Among them, benzoic acid is particularly preferable.

Esterified compounds of oligosaccharide may be employed as a compound which includes 1 to 12 of at least one kind of a furanose structure or a pyranose structure relating to the present invention.

The oligosaccharide can be produced by action of ferment such as amylase to starch, cane sugar and so on. Examples of oligosaccharides usable in the present invention, include marthe oligosaccharide, isomarthe oligosaccharide, fructo oligosaccharide, galact oligosaccharide, and xylo oligosaccharide.

Moreover, the above-mentioned ester compound may be a compound in which one or more and 12 or less of at least one kind of the pyranose structure or the furanose structure represented by the following Formula (A) are condensed. In Formula (A), R₁₁ to R₁₅, and R₂₁ to R₂₅ each represents an acyl group with 2 to 22 carbon atoms or a hydrogen atom, m and n represent an integer of 0 to 12 respectively, and in +n represents an integer of 1 to 12.

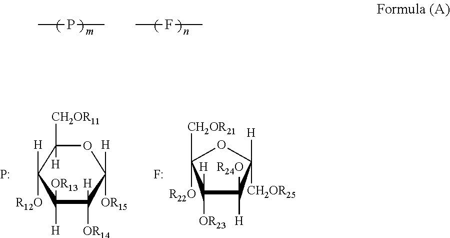

R₁₁ to R₁₅, and R₂₁ to R₂₅ may be preferably a benzoyl group and a hydrogen atom. The benzoyl group may further include a substituent R26 (p is 0 to 5), and examples of the substituent R26 include an alkyl group, an alkenyl group, an alkoxyl group, and a phenyl group. Furthermore, these alkyl group, alkenyl group, and phenyl group may also include substituent. The oligosaccharide may also be produced by the same method as the ester compound of the present invention.

Concrete examples of the esterified compound relating to the present invention are listed below, but the present invention is not limited to these examples.

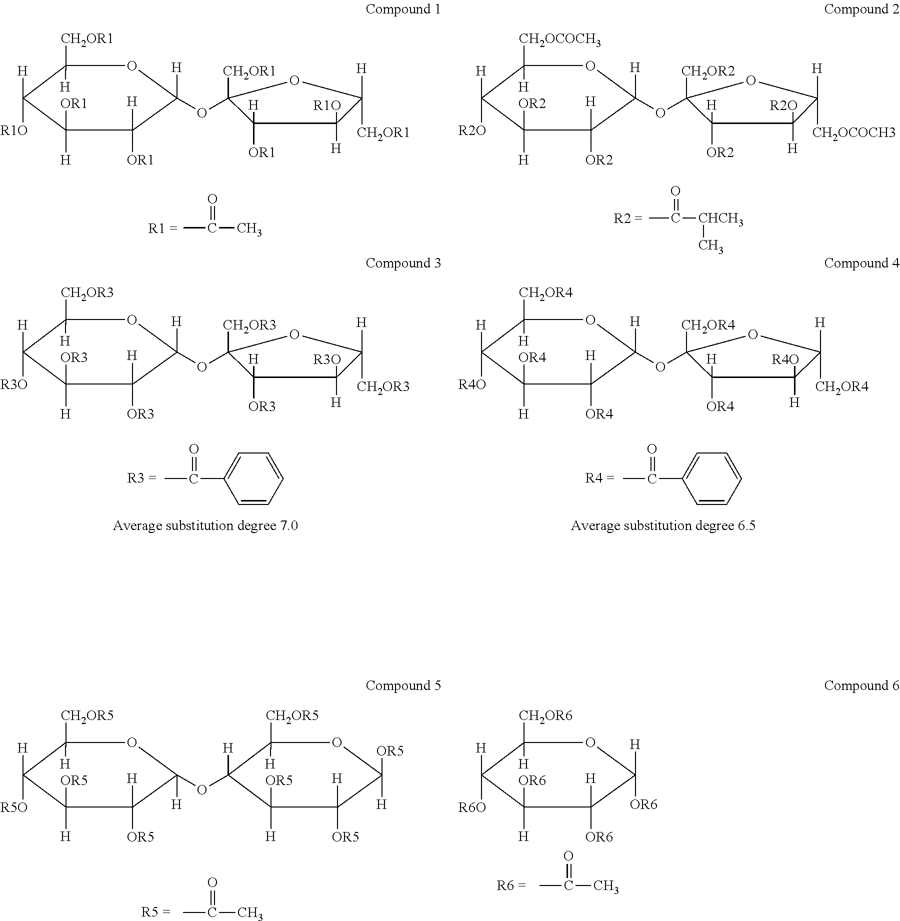

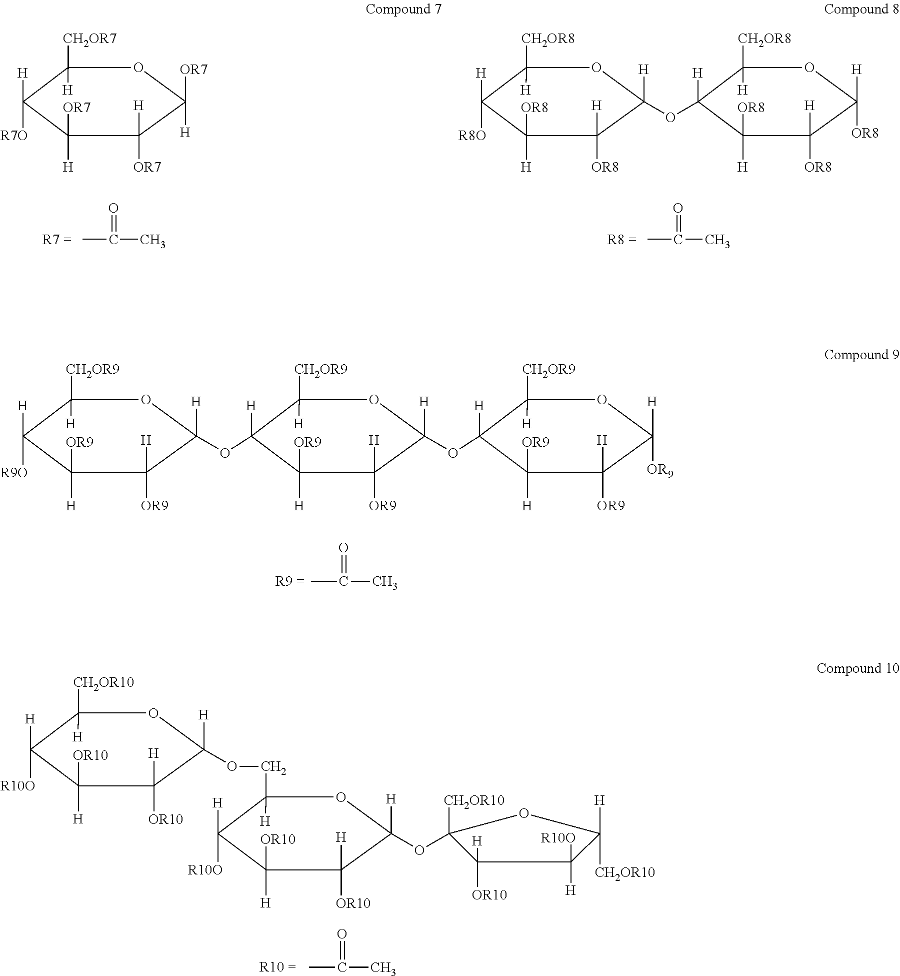

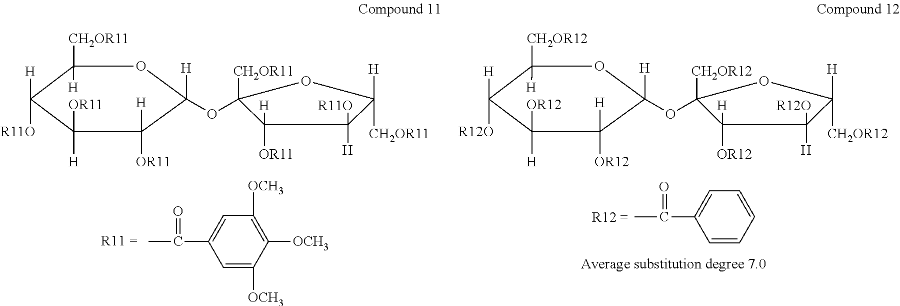

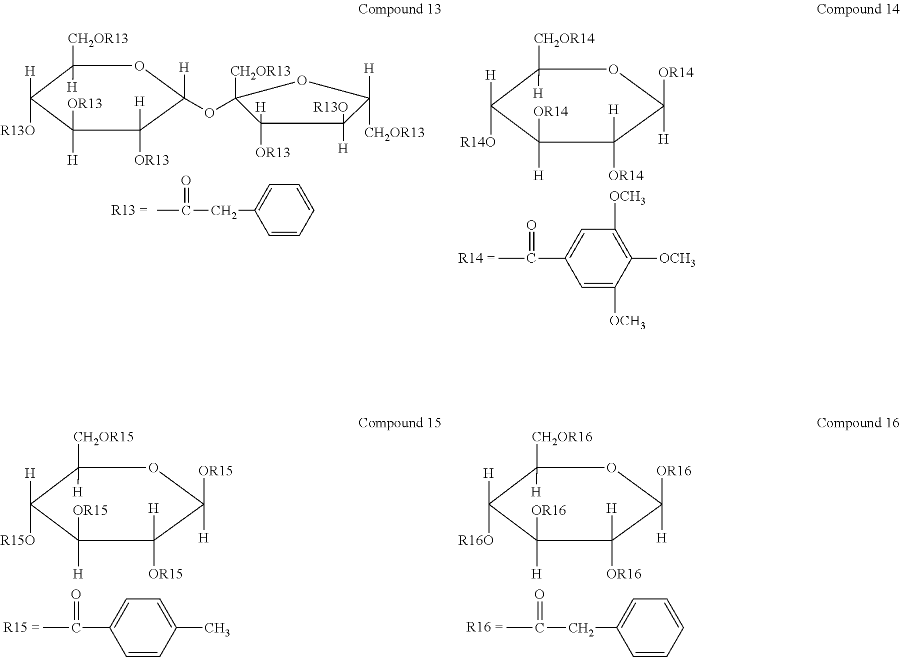

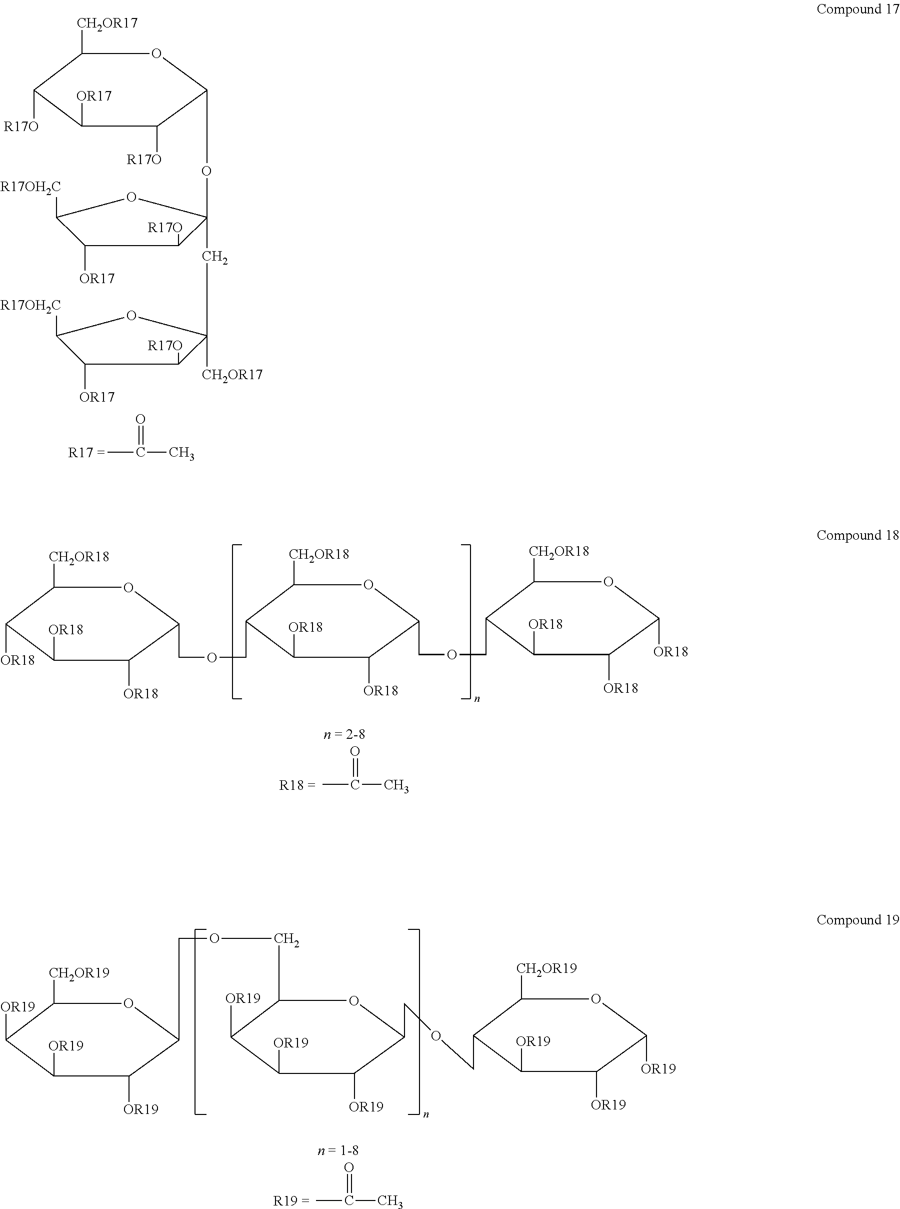

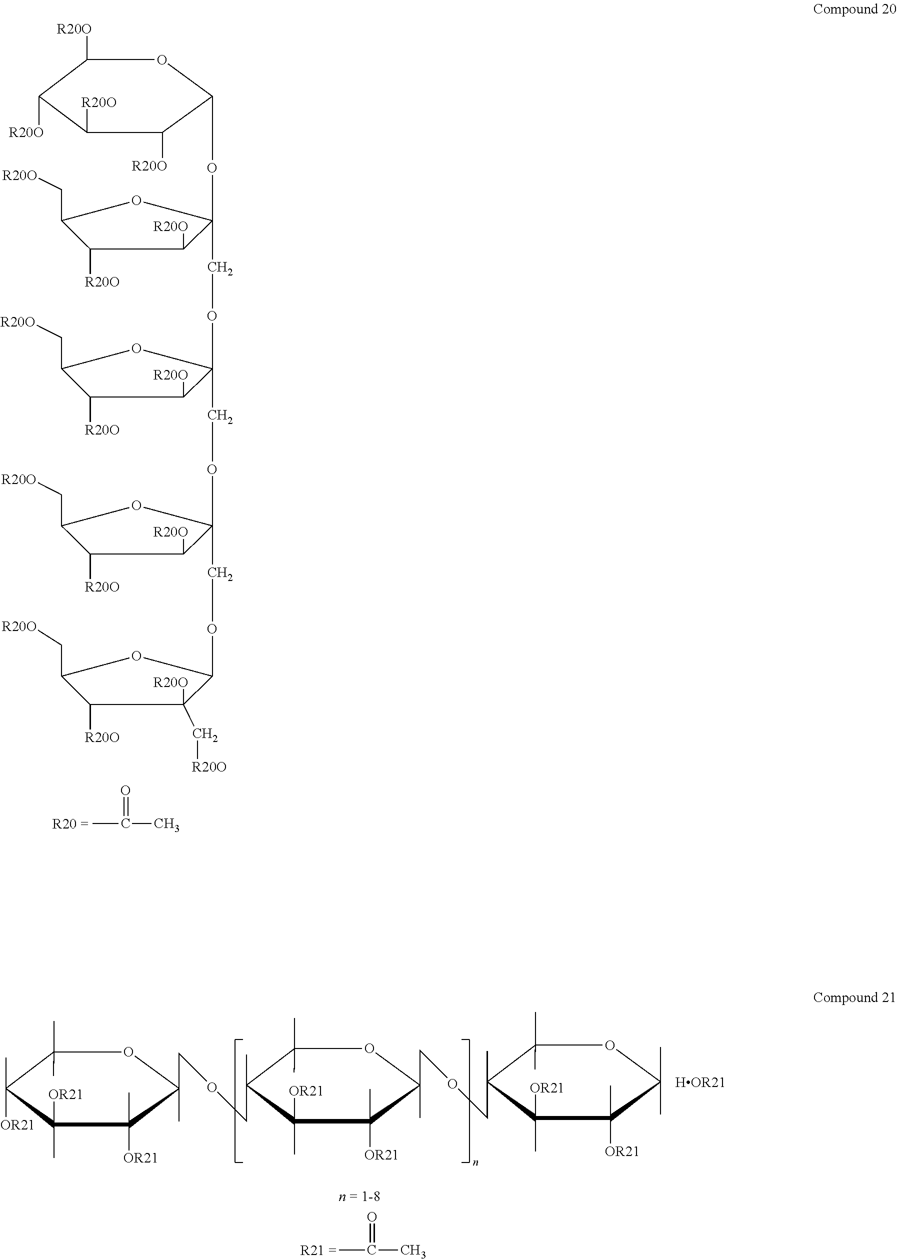

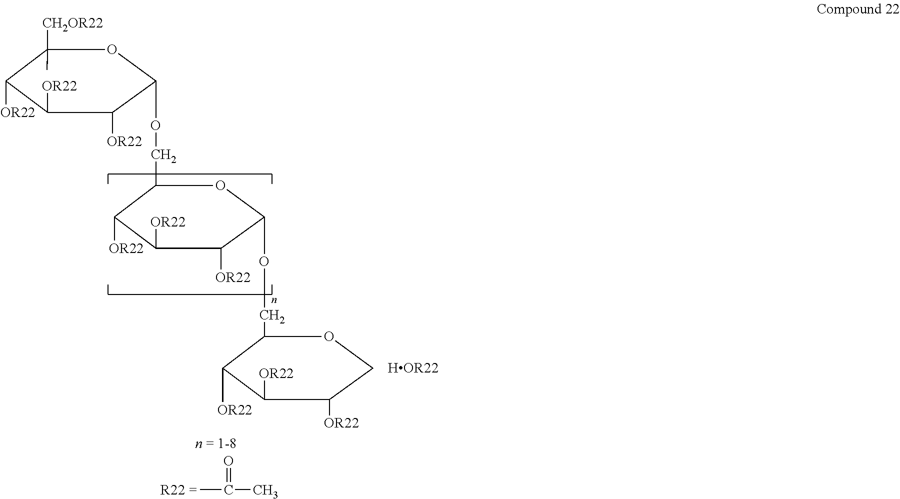

Further, it is desirable to use a compound with the structure represented by Formula (c) for the second cellulose ester film used in the present invention. The compound with the structure represented by Formula (c) is a polyester type plasticizer, and the polyester type plasticizer which includes an aromatic ring or a cycloalkyl ring in its molecule may be used.

B−(G−A)ₙG−B Formula (C)

where B represents benzene monocarboxylic acid group, G represents an alkylene glycol group having 2-12 carbon atoms, an aryl glycol group having 6-12 carbon atoms, or an oxyalkylene glycol group having 4-12 carbon atoms, A represents an alkylene dicarboxylic acid having 4-12 carbon atoms, or an aryl dicarboxylic acid group having 6-12 carbon atoms, and n represents an integer of 1 or more.

A compound represented by Formula (C) is structured by benzene monocarboxylic acid group represented with B, an alkylene glycol group or an oxyalkylene glycol group or an aryl glycol group represented with G, and an alkylene dicarboxylic acid group or an aryl dicarboxylic acid group represented with A and is prepared through a reaction similar to the preparation reaction of a common polyester plasticizer.

Examples of a benzene monocarboxylic acid component of the ester plasticizer of the present invention include: benzoic acid, p-tert-butyl benzoic acid, o-toluic acid, m-toluic acid, p-toluic acid, dimethyl benzoic acid, ethyl benzoic acid, n-propyl benzoic acid, aminobenzoic acid and acetoxy benzoic acid, which may be used alone or in combination of two or more acids.

Examples of an alkylene glycol component having 2 to 12 carbon atoms of the polyester plasticizer preferably usable for the second cellulose ester film used in the present invention include: ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (also known as neopentylglycol), 2,2-diethyl-1,3-propanediol (also known as 3,3-dimethylol pentane), 2-n-butyl-2-ethyl-1,3-propanediol (also known as 3,3-dimethylol heptane), 3-methyl-1,5-pentanediol-1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, which may be used alone or in combination of two or more glycols.

Since alkylene glycol having carbon atoms of 2 to 12 is especially excellent in compatibility with cellulose ester, it is especially desirable.

Examples of an oxyalkylene glycol component having 4 to 12 carbon atoms of the aromatic terminal ester of the present invention include: diethylene glycol, triethylene glycol, tetraethylene glycol, dipropylene glycol and triropylene glycol, which may be used alone or in combination of two or more glycols.

Examples of an alkylene dicarboxylic acid component having 4 to 12 carbon atoms of the aromatic terminal ester of the present invention include: succinic acid, maleic acid, the fumaric acid, glutaric acid, adipic acid, azelaic acid, sebacic acid and dodecane dicarboxylic acid, which may be used alone or in combination of two or more acids. Examples of an arylene dicarboxylic acid component having 6 to 12 carbon atoms include: phthalic acid, terephthalic acid, 1,5-naphthalene dicarboxylic acid and 1,4-naphthalene dicarboxylic acid.

The number average molecular weight of the polyester plasticizer used in the second cellulose ester film relating to the present invention is preferably 300 to 1500, and more preferably 400 to 1000. The acid value of the polyester plasticizer used in the present invention is 0.5 mgKOH/g or less and the hydroxyl value is 25 mgKOH/g or less, more preferably, the acid value is 0.3 mgKOH/g or less and the hydroxyl value is 15 mgKOH/g or less.

Although concrete compounds of the aromatic terminal ester type plasticizer with the structure represented by Formula (C) and usable in the present invention are shown below, the present invention is not limited to these.

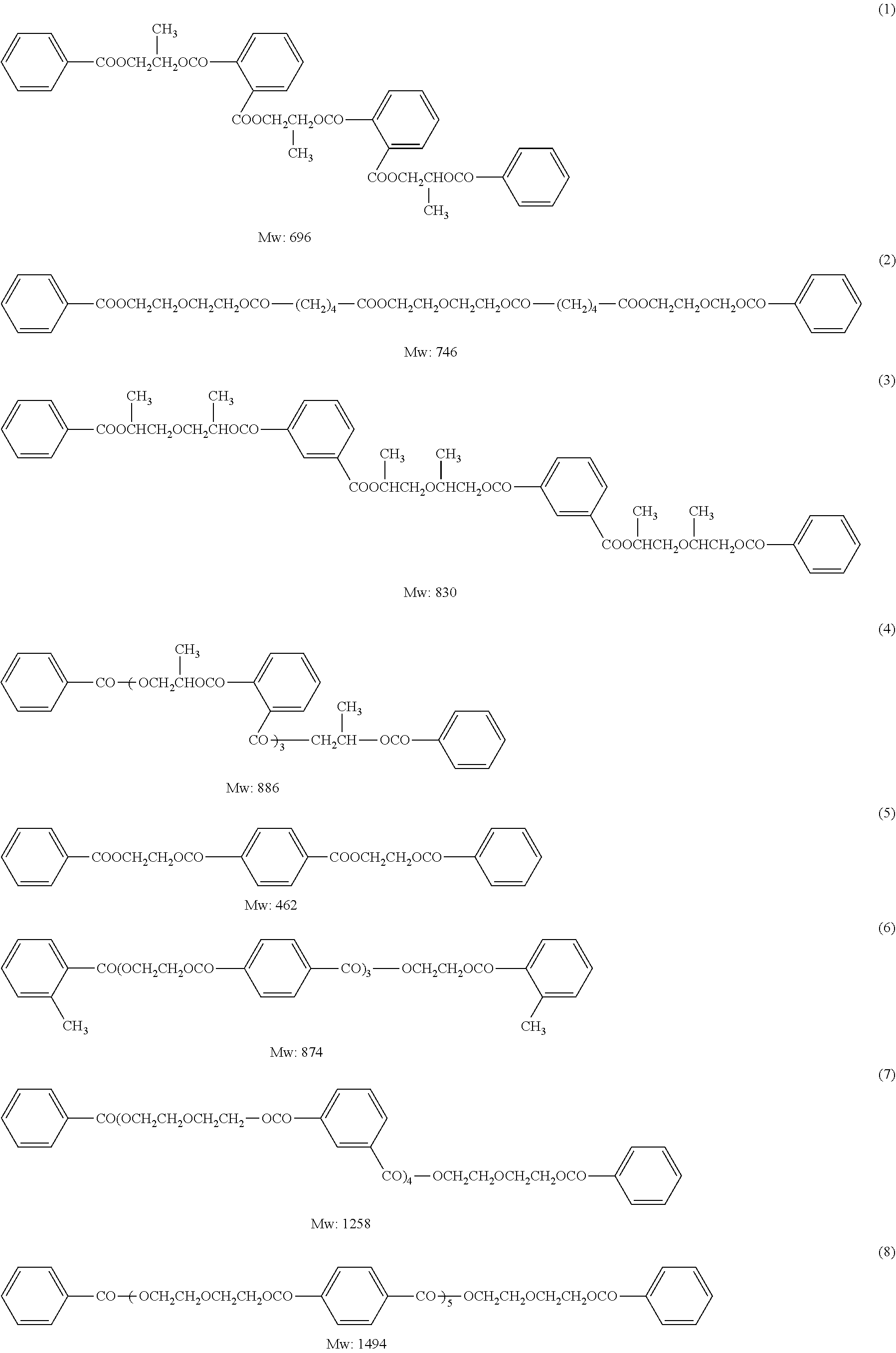

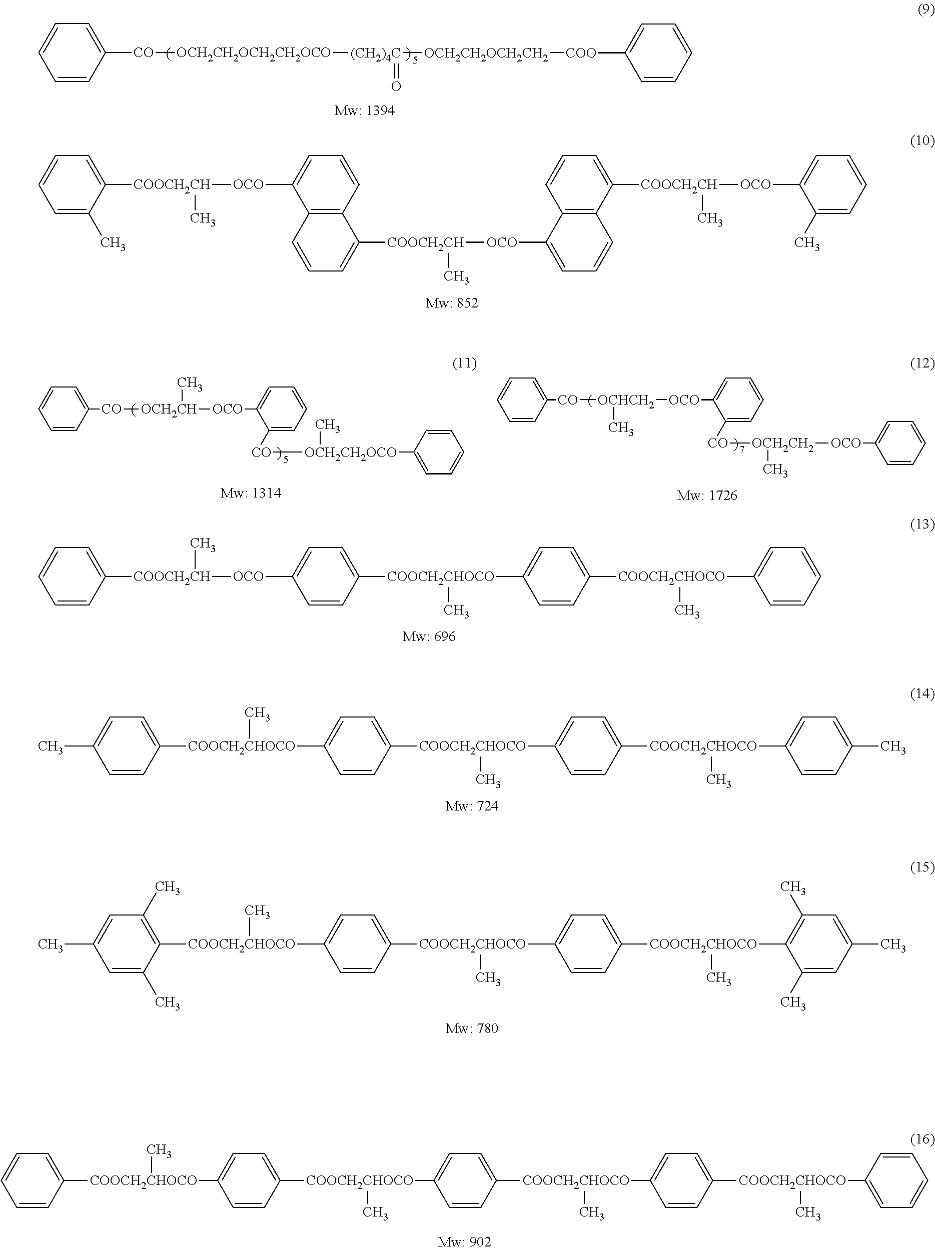

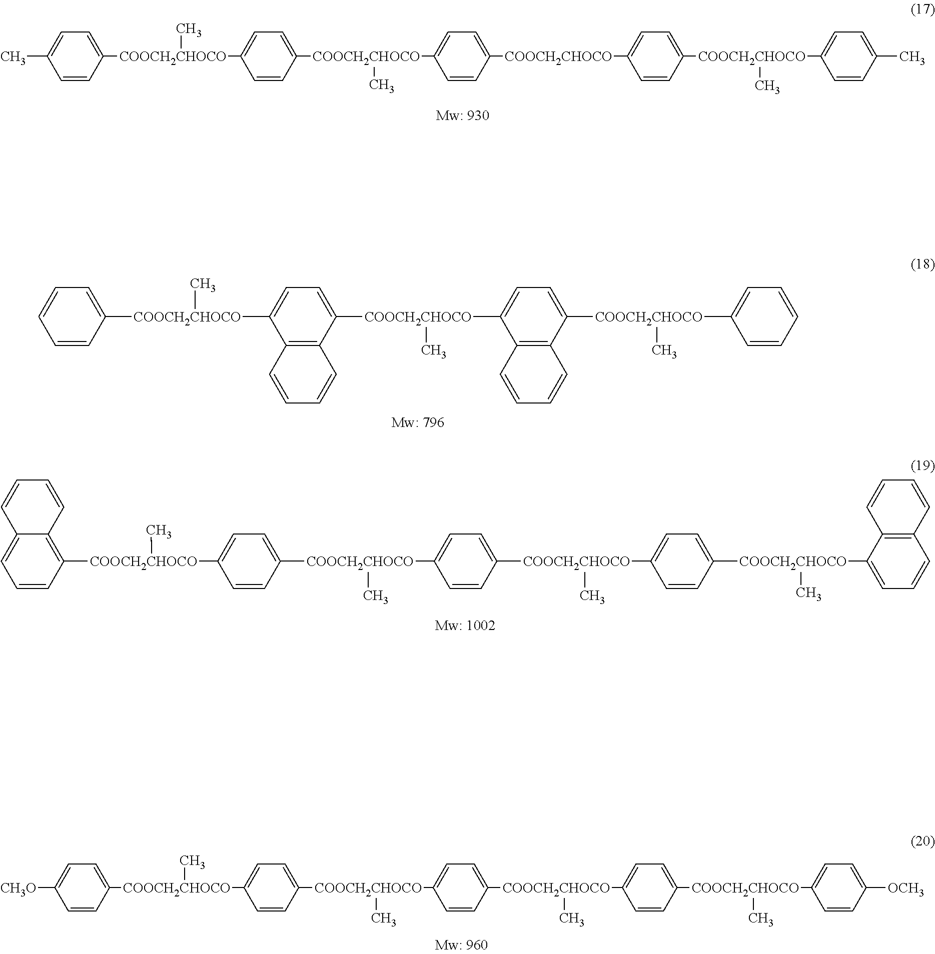

### <Other Additives>

### <Ultraviolet Absorber>

UV absorber is preferably employed for cellulose ester film (especially, the first cellulose ester film) relating to the present invention. As such a UV absorber, a UV absorber with less absorption of visible rays with a wavelength of 400 nm or more is preferably used from viewpoints of excellent absorption property for ultraviolet rays with a wavelength of 370 nm or less and excellent liquid crystal display property.

Examples of a UV absorbing agent preferably used in the present invention include: an oxybenzophenone based compound, a benzotriazol based compound, a salicylic acid ester based compound, a benzophenone based compound, a cyanoacrylate based compound, a triazinebased compound and a nickel complex salt.

Examples of benzotriazol based UV absorbing agent will be given below, however, the present invention is not limited thereto.

UV-1: 2-(2′-hydroxy-5′-methylphenyl)benzotriazole

UV-2: 2-(2′-hydroxy-3′,5′-di-tert-butylphenyl)benzotriazole

UV-3: 2-(2′-hydroxy-3′-tert-butyl-5′-methylphenyl)benzotriazole

UV-4: 2-(2′-hydroxy-3′,5′-di-tat-butylphenyl)-5-chloro benzotriazole

UV-5: 2-(2′-hydroxy-3′-(3″,4″,5″,6″-tetrahydrophthalimidomethyl)-5′-methylphenyl)benzotriazole

UV-6: 2,2-methylenebis (4-(1,1,3,3-tetramethylbutyl)-6-(2H-benzotriazole-2-yl) phenol)

UV-7: 2-(2′-hydroxy-3′-tert-butyl-5′-methylphenyl)-5-chlorobenzotriazole

UV-8: 2-(2H-benzotriazole-2-yl)-6-(n- and iso-dodecyl)-4-methylphenol (TINUVIN171, product of Ciba Specialty Chemicals Inc.)

UV-9: Mixture of octyl-3-[3-tert-butyl-4-hydroxy-5-(chloro-2H-benzotriazole-2-yl) phenyl]propionate and 2-ethylhexyl-3-[3-tert-butyl-4-hydroxy-5-(5-chloro-2H-benzotriazole-2-yl)phenyl]propionate (TINUVIN109, product of Ciba Specialty Chemicals Inc.)

Further, specific examples of a benzophenone based compound are shown below, however, the present invention is not limited thereto.

UV-10: 2, 4-dihydroxy benzophenone

UV-11: 2,2′-dihydroxy-4-methoxybenzophenone

UV-12: 2-hydroxy-4-methoxy-5-sulfobenzophenone

UV-13: Bis(2-methoxy-4-hydroxy-5-benzoylphenyl methane)

As UV absorbing agent preferably used in the present invention, the benzotriazole or benzophenone type UV absorbing agent is preferably used, because of high transparency, and excellence in effect to prevent deterioration of a polarizing plate and a liquid crystal. The benzotriazole type UV absorbing agent is especially preferably used, because of lesser undesired coloration.

The UV absorbing agent disclosed in JP-A No. 2001-187825 having a distribution coefficient of 9.2 or more provide an improved surface quality of a long roll film and a favorable coating property. Preferable is a UV absorbing agent having a distribution coefficient of 1.01 or more.

A polymer UV absorbing agent (or a UV absorbing polymer) disclosed in Formula (1) or (2) in JP-A No. 6-148430 or Formula (3), (6) or (7) in JP-A No. 2000-156039 is also preferably employable. PUVA-30M (produced by OTSUKA Chemical Co., Ltd.) is commercially available as a polymer UV absorbing agent

### <Fine Particles>

In order to provide slipping properties to the first and second cellulose ester films of the present invention, it is desirable to add fine particles.

The primary average particle size of fine particles is preferably 20 nm or less, more preferably 5 to 16 nm, and specifically preferably 5 to 12 nm.

These fine particles are preferably contained in a retardation film with the formation of secondary fine particles with a particle size of 0.1 to 5 μm, and the average particle size is preferably 0.1 to 2 μm, and preferably 0.2 to 0.6 μm. With this, convexo-concave patterns with a height of about 0.1 to 1.0 μm high can be formed on a film surface, whereby suitable slipping properties can be given to the film surface.

Measurement of the primary average particle size of the fine particles used for the present invention is conducted such that 100 particles are observed with a transmission type electron microscope (magnification of 500,000 to 2000,000 times) so as to measure the diameter of the particles and to determine the mean value of the measured diameters as a primary average particle diameter.

An apparent specific gravity of the fine particles is desirably 70 g/liter, more preferably 90 to 200 g/liter, and still more preferably 100 to 200 g/liter. When the apparent specific gravity is larger, it may become more possible to make a high-concentration dispersion liquid and it may become preferable that a haze and a coagulum may be improved. Further, in the case where a dope solution having a high solid concentration is prepared as being like the present invention, it is used especially preferably.

Silicon dioxide fine particles having a mean diameter of primary particles of 20 nm or less and an apparent specific gravity of 70 g/liter or more can be obtained such that, for example, a mixture of vaporized silicon tetrachloride and hydrogen is burn in air at 1000 to 1200° C. Further, for example, silicon dioxide fine particles are commercially available with the trade name of Aerosil 200V and Aerosil R972V (all the above, produced by Japanese Aerosil Corporation), and they can be employed in the present invention.

The apparent specific gravity of the above-mentioned description can be calculated with the following ways, a predetermined quantity of silicon dioxide fine particles is taken in a measuring cylinder, the weight of them is measured at this time and the apparent specific gravity is calculated with the following formula.

Apparent specific gravity (g/liter)=the weight (g) of silicon dioxide fine particles/the volume (liter) of silicon dioxide fine particles

The following three kinds of methods, for example, may be employed as a method of preparing a dispersion solution of fine particles usable in the present invention and a method of adding it in a dope.

### <<Preparing Method A>>

After stirring and mixing solvent and fine particles, the mixture is dispersed by a homogenizer: The resultant dispersion solution is made as a fine particle dispersion liquid. The fine particle dispersion liquid is added in a dope solution and is stirred.

### <<Preparing Method B>>

After carrying out stirring mixing a solvent and fine particles, the mixture is dispersed by a homogenizer. The resultant dispersion solution is made as a fine particle dispersion liquid. Separately, a small amount of cellulose triacetate is added in a solvent and dissolved by stirring. The resultant solution is added with the fine particle dispersion liquid and is stirred. The resultant liquid is made as a fine particle additive liquid. The fine particle additive liquid is added in a dope solution and is stirred with a line mixer.

### <<Preparing Method C>>

A small amount of cellulose triacetate is added in a solvent and dissolved by stirring. The resultant solution is added with fine particle and is dispersed by a homogenizer. The resultant liquid is made as a fine particle additive liquid. The fine particle additive liquid is added in a dope solution and is stirred with a line mixer.

Preparing method A is excellent in dispersion ability for the silicon dioxide fine particles, and Preparing method C is excellent in that the silicon dioxide fine particles hardly recoagulates. Among them, Preparing method B described above is excellent in both the point of the dispersion ability for the silicon dioxide fine particles and the point that the silicon dioxide fine particles hardly recoagulates, therefore, is more preferable.

### <<Dispersing Method>>

When mixing silicon dioxide fine particles with a solvent etc., the concentration of the silicon dioxide is desirably 5% by weight to 30% by weight, more desirably 10% by weight to 25% by weight, most desirably 15% by weight to 20% by weight. When the dispersion concentration is higher, liquid turbidity to added amount tends to become low and a haze and a coagulum may be improved, therefore it may be preferable.

The organic solvent used for dispersion is desirably a lower alcohol. As the lower alcohol, methanol, ethanol, propyl alcohol, isopropyl alcohol, butanol, etc. may preferably be listed. Although a solvent other than the lower alcohol is not limited especially, it is desirable to use a solvent which is used at the time of preparing a dope.

The added amount of silicon dioxide fine particles to a cellulose ester is desirably 0.01 to 0.5 parts by weight of silicon dioxide fine particles to 100 pars by weight of cellulose ester, is more desirably 0.05 to 1.0 parts by weight, and is most desirably 0.1 to 0.5 parts by weight. When the added amount is larger, it may be excellent in a dynamic friction coefficient, and when the added amount is smaller, haze is low and a coagulum becomes little.

As a homogenizer, a usual homogenizer can be used. The homogenizer is roughly divided into a media homogenizer and a medialess homogenizer. As a homogenization for silicon dioxide fine particles, the medialess homogenizer is desirable, because of low haze. As the media homogenizer, a ball mill, a sandmill, a dieno mill, etc. are may be listed.

Although a supersonic wave type, a centrifugal type, a high-pressure type, etc may be employed as the medialess homogenizer, a high-pressure homogenization apparatus is desirable in the present invention. The high-pressure homogenization apparatus is an apparatus to create a special condition such as a high shearing and a high-pressure state by making a composition mixed of fine particles and a solvent to pass at a high speed through a small tube.

When processing with the high-pressure homogenization apparatus, it is desirable that the maximum pressure condition in a small tube having a pipe diameter of 1 to 2000 μm in the apparatus is 9.8 MPa or more.

The maximum pressure condition is more preferably 19.6 MPa or more. At this time, an apparatus in which the highest arrival velocity reaches 100 msec. or more, or an apparatus in which a rate of heat transfer reaches that more than 420 kJ/hour is desirable.

Example of the high pressure dispersing apparatus includes an ultra high speed homogenizer (commercial name: Microlluidizer) manufactured by Microfluidics Corporation and Nanomizer manufactured by Nanomizer Nanomizer Co., Ltd. Other than the above, Manton-Goulin type high pressure dispersing apparatus such as a homogenizer manufactured by Izumi Food Machinery Co., Ltd is applicable.

Further, it is preferable to cast dope containing fine particles so as to come directly in contact with a casting support member, because a film with high slipping properties and low haze can be obtained.

Moreover, the above-mentioned cellulose resin film is separated after casting, is dried and wound up in a rolled form, thereafter, there may be a case where the cellulose resin film is provided with a functional thin layer, such as a hard coat layer and an antireflection layer. In order to protect a cellulose resin film as a product from a soil and waste adhesion by static electricity, the cellulose resin film is usually subjected to a package process until it is processed or shipped.

With regard to a packaging material, as far as the above-mentioned purpose can be achieved, it will not be limited especially, but the packaging material which does not prevent vaporization of remaining solvent from the film is desirable. Concretely, polyethylene, polyester, polypropylene, nylon, polystyrene, paper, various nonwoven fabrics, etc. are listed as the packaging material. A packaging material in which fiber became mesh cross state is used more preferably.

### <Method for Producing the First and Second Cellulose Ester Films of the Present Invention>

Next, description will be given with regard to method for producing the first and second cellulose ester films of the present invention.

Even if the first and second cellulose ester films of the present invention are films produced by melt casting method or films produced by solution casting method, these films can be used preferably.

The manufacture of the first and second cellulose ester films of the present invention is conducted by a process of dissolving cellulose ester and additives in a solvent so as to prepare a dope; a process of casting the dope on an endless metal support member which shifts endlessly; a process of drying the cast dope as a web, a process of peeling the web from the metal support member, a process of stretching or holding the width, a process of drying the web further, and a process of winding up the finished film.

A process of preparing a dope is further stated, that is, a higher content or concentration of cellulose resin in the dope is preferable since the load of the drying process following the flow-casting process on a metal support is reduced, however, if the concentration of cellulose resin is too high, the load of the filtration becomes larger and filtration accuracy becomes worse. Preferable content of cellulose resin to satisfy the both is from 10 to 35 percent by weight and more preferably from 15 to 25 percent.

A solvent used in the dope of the present invention may be used alone, however, two or more solvents may also be used together. A mixture of a good solvent for cellulose resin and a poor solvent is more preferably used to increase manufacturing efficiency. A mixed solvent being rich in a good solvent is preferable to increase solubility of the cellulose resin.

The preferable mixing ratio is from 70 to 98 percent by weight of a good solvent, and from 2 to 30 percent of a poor solvent. Herein, the good solvent is defined as being capable of dissolving cellulose resin with a single use, and a poor solvent as swelling or being incapable of dissolving cellulose ester with a single use.

Sometimes, a solvent works as a good solvent of a cellulose ester, and sometimes as a poor solvent depending on the acetification degree (degree of acetyl substitution) of the cellulose ester. For example, acetone becomes a good solvent for an acetic ester of a cellulose resin of which the acetification degree is 2.4, as well as for a cellulose acetatepropionate, however, it becomes a poor solvent for an acetic ester of cellulose of which the acetification degree is 2.8.

Good solvents used in the present invention include, for example: organic halides (such as methylene chloride), dioxolanes, acetone, methyl acetate and methyl acetoacetate, of which methylene chloride and methyl acetate are specifically preferable. However, the present invention is not specifically limited thereto.

Poor solvents used in the present invention include, for example: methanol, ethanol, n-butanol, cyclohexane and cyclohexanone, however, the present invention is not specifically limited thereto. A dope may preferably contain from 0.01 to 0.2 percent by weight of water.

Further, as a solvent utilized for dissolution of cellulose ester, a solvent removed from film by drying in a film casting process is recovered and reused.

In a recovered solvent, a trace amount of additives such as a plasticizer, an ultraviolet absorbent, polymer or monomer components may be contained, however, the solvent may be utilized even containing them or may be utilized appropriately after purification.

In the process of preparing a dope, a cellulose ester is dissolved in a mixture of solvents using a common method. Dissolving a cellulose ester at a higher temperature is possible when the heating is carried out under a higher pressure.

Formation of a gel or an insoluble agglomerate (known as “Mamako” in Japanese which represents insoluble residue when powder is dissolved in a solvent) may be avoided when the dissolving temperatures is higher than the ambient pressure boiling point of the mixed solvents, and simultaneously the temperature is in the range where the mixed solvents do not boil under the applied higher pressure.

The following dissolving method is also preferable, in which a cellulose ester is swollen in a mixture of good and poor solvents followed by adding good solvents to dissolve the swollen cellulose ester.

Pressure may be applied by injecting an inert gas such as nitrogen or by increasing the vapor pressure of the solvents by heating. Heating is preferably carried out from the outside of the container. A jacket type heater is preferable because the temperature is easily controlled.

A higher dissolving temperature is preferable with respect to the solubility of the cellulose ester, however, too high a temperature may lower the productivity because the pressure also becomes too high.

The dissolving temperature is preferably from 45 to 120° C., more preferably from 60 to 110° C. and still more preferably from 70 to 105° C. The pressure should be controlled not to allow boiling at the set temperature.

A low temperature dissolution method is also preferably utilized, by which cellulose ester is successfully dissolved in solvents such as methyl acetate.

In the next step, the cellulose ester solution thus prepared is filtered using an appropriate filter material. A filter material with a smaller absolute filtration accuracy is more preferable for removing impurities, however, too small a filtration accuracy easily cause clogging up of the filter.

The absolute filtration accuracy of the filter is preferably not larger than 0.008 mm, more preferably from 0.001 to 0.008 mm and still more preferably from 0.003 to 0.006 mm.

The filter material used in the present invention is not specifically limited, and plastic filters (such as polypropylene and Teflon(R)) as well as metal(alloy) filters (such as stainless steel) are preferable, since these materials are free from peeling of a fiber, which may occur when fibrous material is used.

Impurities and, particularly, luminescent foreign materials contained in the cellulose ester are preferably diminished or entirely removed by filtering.

“Luminescent foreign materials” denote impurities which are observed as bright spots when a cellulose ester film is placed between two polarizing plates arranged in a crossed Nicol state, illuminated with a light from one side and observed from the other. The number of luminescent foreign materials of larger than 0.01 mm in diameter is preferably less than 200 per cm².

More preferably is less than 100 per cm² and still more preferably is from 0 to 10 per cm². The number of luminescent foreign materials of less than 0.01 mm in diameter is preferably minimal.

The dope may be filtered by any common method. One of these preferable filtering methods is to filter the dope at temperatures which are higher than the ambient pressure boiling point of the mixed solvents, and simultaneously in the range where the mixed solvents do not boil under a higher pressure. This method is preferable because the pressure difference between before and after filtering is reduced.

The filtering temperature is preferably from 45 to 120° C., more preferably from 45 to 70° C. and still more preferably from 45 to 55° C.

The pressure applied during filtering is preferably low, being preferably less than 1.6 MPa, more preferably less than 1.2 MPa and still more preferably less than 1.0 MPa.

Casting of a Dope will be Explained Below:

A metal support polished to a mirror finished surface is used in the flow-casting process. A polished stainless steel belt or a plated cast drum is used as a metal support.

The width of the support is preferably from 1 to 4 m. The surface temperature of the metal support is preferably from −50° C. to a temperature just below the boiling point of the solvent. A relatively high temperature of the support is more preferable because the web is more quickly dried, however, too high a temperature may cause foaming or loss of flatness of the web.

The temperature of the support depends on the solvent, however, is preferably in the range of 0 to 55° C., and more preferably 25 to 55° C. Another preferable method is that a web is gelated by cooling the drum followed by peeling the web from the drum while the web still contains much solvent.

The method to control the temperature of the support is not specifically limited and a method of blowing warm or cool air onto the support or to apply warm water on the rear side of the support is acceptable. The warm water method is more preferable because the temperature of the metal support becomes stable in a shorter time due to more efficient thermal conduction. In the case when warm air is used, an air temperature higher than the desired temperature is sometimes used.

In order to obtain a cellulose ester film with a sufficient flatness, the residual solvent content of the web when it is peeled from a metal support is preferably 10-150% by weight, however, it is more preferably 20-40% by weight or 60-130% by weight. The residual solvent content is specifically more preferably 20-30% by weight or 70-120% by weight.

The residual solvent content of the web is defined by the following formula:

Residual solvent content (% by weight)={(M−N)/N}×100

where M represents the weight of a sample of the web collected in the manufacturing process or after manufacturing, and N represents the weight of the same sample after it was dried at 115° C. for 1 hour.

In the drying process of a cellulose ester film, the film is peeled from the support and further dried until the residual solvent decreases below not more than 1 weight %, more preferably not more than 0.1 weight %, specifically preferably 0-0.01 weight %.

In the film drying process, usually a roll drying method in which a cellulose ester film is passed through many rollers placed alternatively up and down in a staggered manner or a drying process to dry while conveying a film with a tenter method may be employed.

In order to produce the cellulose ester film of the present invention, the stretching of a web in the width direction (transverse direction) with a tenter technique which grips the both ends of the web with a clip etc. is specifically desirable. The web is preferably peeled with a tension of 300 N/m or less.

The method to dry the web is not specifically limited, however, generally, hot air, IR ray, heated rollers or microwave irradiation is used. Hot air is preferably used with respect to ease of cure and low cost.

The preferable drying temperature of a web is from 40 to 200° C. and is preferably increased stepwise.

A cellulose ester film relating to the present invention has preferably a width of from 1 to 4 m, more preferably a width of from 1.4 to 4 m, and specifically preferably a width of from 1.6 to 3 m. Further, the thickness of the cellulose ester film is 20 to 120 μm, and preferably 30 to 70 μm,.

The target retardation values Ro and Rt of the second cellulose ester film of the present invention may be obtained by the cellulose ester film with the raw material structure of the present invention, and further the control of conveyance tension, and the control of refractive index by a stretching operation.

For example, it is possible to perform successive or simultaneous stretching in the longitudinal direction of film (the cast direction) and in the direction perpendicular thereto, that is, in the width direction.

The stretching magnifications in the biaxial directions perpendicular to each other are preferably set to finally 0.8 to 1.5 times in the cast direction and 1.1 to 2.5 times in the width direction, and more preferably set to 0.8 to 1.0 times in the cast direction and 1.2 to 2.0 times in the width direction.

The stretching temperature is preferably 120° C. to 200° C., more preferably 150° C. to 200° C., still more preferably higher than 150° C. and not higher than 190° C.

It may be preferable to stretch a film under the condition where the content of the residual solvent in the film is 20 to 0%, more preferably 15 to 0%.

More concretely, the film is preferably stretched under the condition that the content of the residual solvent is 11% at 155° C., or the content of the residual solvent is 2% at 155° C. Otherwise, the content of the residual solvent is 11% at 160° C., or the content of the residual solvent is not higher than 1% at 160° C.

A method to stretch a web is not specifically limited. For example, listed a method to stretch in the longitudinal direction by making a circumferential speed difference among plural rolls and utilizing the roll circumferential speed difference among them, a method to stretch in the longitudinal direction by fixing the both edge of a web with clips or pins and widening the intervals between clips and pins toward the proceeding direction, a method to stretch by widening similarly along the width direction, or a method to stretch in the both of longitudinal and width directions by simultaneously widening along the longitudinal and width directions. Of cause, these methods can be utilized in combination.

In a so-called tenter method, it is preferable that a smooth stretching can be performed by driving the clip portion by a linear drive method which reduces risk to such as break.

It is preferable to perform the width holding or stretching in the width direction by a tenter, which may be either a pin tenter or a clip tenter.

The slow axis or the fast axis of optical compensation film of this invention preferably is present in a film plane and θ1 is preferably not less than −1° and not more than +1°, and more preferably not less than −0.5° and not more than +0.5°, when the angle against the casting direction is θ1.

This θ1 can be defined as an orientation angle, and measurement of θ1 can be performed by use of automatic double refractometer KOBRA-21ADH (Oji Scientific Instruments). To satisfy the above-described relationships by θ1 can contributes to obtain a high luminance and to restrain or prevent light leak, and to obtain faithful color reproduction in a color liquid display device.

### (Physical Properties of the First and Second Cellulose Ester Films of the Present Invention)

Moisture permeability of the first and second cellulose ester films relating to the present invention is preferably 300 to 1,800 g/m²·24 h, more preferably 400 to 1,500 g/m²·24 h and specifically preferably 40 to 1,300 g/m²·24 h at 40° C., 90% RH. Moisture permeability can be measured according to a method described in HS Z 0208.

Elongation percentage of the first and second cellulose ester films relating to the present invention is preferably 10 to 80% and more preferably 20 to 50%.

Visible light transmittance of the first and second cellulose ester films relating to the present invention is preferably not less than 90% and more preferably not less than 93%.

Haze of the first and second cellulose ester films relating to the present invention is preferably less than 1% and specifically preferably 0 to 0.1%.

In the second cellulose ester film relating to the present invention, it is desirable that difference in refractive index between its one surface and its opposite surface (also referred to as a film obverse surface and reverse surface) is in a range of 5×10⁻⁴ or more and 5×10⁻³ or less.

The reason why is as follows. If a polarizing plate is made thin, the stiffness of the polarizing plate becomes weak. Accordingly, when the polarizing plate is pasted on a liquid crystal cell, generation of air bubbles and positional deviation tend to occur. Therefore, curl intentionally given to the second cellulose ester film enhances the stiffness of the polarizing plate, whereby the above problems at the time of pasting of the polarizing plate onto the liquid crystal cell can be reduced.

### <Function Layer>

The hard coat film according to the present invention may be provided with function layers, such as an antistatic layer, a back coat layer, an antireflection layer, a smoothness assist layer, an adhesive layer, an antiglare layer, a bather layer, and the like.

### <Back Coat Layer>

In the hard coat film, in order to prevent curling and sticking, a back coat layer may be provided on a surface of a substrate film opposite to the surface on which a hard coat layer is provided.

Examples of particles added to the back coat layer include inorganic micro particles, for example, silicon dioxide, titanium dioxide, aluminum oxide, zirconium oxide, calcium carbonate, calcium carbonate, talc, clay, calcined kaolin, calcined calcium silicate, tin oxide, indium oxide, zinc oxide, ITO, hydrated calcium silicate, aluminum silicate, magnesium silicate and calcium phosphate. The content of particles contained in the back coat layer is preferably from 0.1 to 50 percent by weight with respect to a binder. The increase in haze after the hard coat film is provided with a back coat layer is preferably 1.5 percent or less, more preferably 0.5 percent or less and specifically preferably 0.1 percent or less. As the binder, cellulose ester resins, such as diacetyl cellulose, may be desirable.

### <Antireflection Layer>

In the hard coat film, an antireflection layer may be coated on the upper layer of a hard coat layer, whereby the hard coat film may be used as an antireflection film having an outdoor daylight reflection prevention function. The antireflection layer is preferably laminated so as to reduce reflectance by optical interference in consideration of refractive index, thickness, the number of layers, and the order of layers. The anti-reflection layer is preferably structured by a low refractive index layer having a lower refractive index than that of the substrate or a combination of a high refractive index layer having a higher refractive index than that of the substrate and a low refractive index layer having a lower refractive index than that of the support. More preferably, the anti-reflection layer is structured by three or more refractive index layers. In this case, three layers different in refractive index are laminated from the substrate side in the order of a medium refractive index layer (with a refractive index higher than that of the substrate and lower than that of a high refractive index layer), a high refractive index layer, and a low refractive index layer. Alternatively, a preferably-employable antireflection layer has a layer configuration of four or more layers in which two or more high refractive index layers and two or more low refractive index layers are laminated alternately.

Although the following structure may be considered as a layer structure of an antireflection film, the present invention should not be limited to these structures.
Substrate film/hard coat layer/low refractive index layer
Substrate film/hard coat layer/middle refractive index layer/low refractive index layer
Substrate film/hard coat layer/middle refractive index layer/high refractive index layer /low refractive index layer
Substrate film/hard coat layer/high refractive index layer (conductive layer)/low refractive index layer
Substrate film/hard coat layer/antiglare layer/low refractive index layer

The low refractive index layer indispensable for an antireflection film preferably contains silica particles, and has a refractive index which is lower than the refractive index of the substrate film being a support, and is preferably in a range of 1.30 to 1.45 by measurement with a wavelength of 550 nm.

The low refractive index layer has preferably a thickness of 5 nm to 0.5 μm, more preferably 10 nm to 0.3 μm, and most preferably 30 nm to 0.2 μm. With regard to a low refractive index layer forming composition, as silica particles, it is preferable to contain at least one kind or more of particles each of which has an outer shell layer specifically and a porous or hollow structure at its inside. Specifically, a particle with an outer shell layer specifically and a porous or hollow structure at its inside is preferably a hollow silica particle.

The low refractive index layer forming composition may be made to contain an organic silicon compound represented by the following Formula (OSi-1), or its hydrolysate, or together with its polycondensation.

Si (OR)₄ Formula (OSi-1):

In the organic silicon compound represented by the above Formula, R represents an alkyl group with 1 to 4 carbon atoms in the formula. Specific examples of the organic silicon compound include tetra methoxy silane, tetra ethoxy silan, tetra isopropoxy silane, and the like. If needed, other solvents, a silane coupling agent, a curing agent, and a surface active agent may be added.

### <Polarizing Plate>

The polarizing plate employing the hard coat film according to the present invention will be described. The polarizing plate can be produced by a general procedure. It may be desirable that the back surface side of the hard coat film according to the present invention is subjected to an alkali saponification treatment, and the treated hard coat film is pasted by use of a fully-saponified polyvinyl alcohol aqueous solution on at least one surface of a polarizing film produced by being immersed in an iodine solution and by being stretched.

On another surface, the above hard coat film may be used, or another polarizing plate protective film may be used. A polarizing plate protective film used on another surface opposite to the hard coat film according to the present invention may be a protective film which contains an acrylic resin and a cellulose ester resin similarly to the substrate film of the hard coat film and has a contained weight ratio of the acrylic resin to the cellulose ester resin (acrylic resin : cellulose ester resin=95:5 to 50:50). The detailed structure is as described above. Specifically, one example is a non-oriented film which is disclosed in Japanese Unexamined Patent Publication No. 2003-12859 and has a retardation value Ro of 0 to 5 nm with a wavelength of 590 nm and Rth of −20 to +20 nm.

Further, in addition, an optical compensation film (retardation film) with retardation values of an in-plane retardation value Ro of 20 to 70 nm with a wavelength of 590 nm and Rth of 70 to 400 nm may be used so as to provide a polarizing plate capable of enlarging a view angle. These films may be produced by the method disclosed by Japanese Unexamined Patent Publication No. No. 2002-71957. Furthermore, an optical compensation film with an optical anisotropy layer formed by orientation of liquid crystal compounds such as discotic liquid crystal may be used. For example, an optical anisotropy layer may be formed by the method disclosed by Japanese Unexamined Patent Publication No. No. 2003-94348.

Preferable examples of the commercially-available polarizing plate protective films include KC8UX2MW, KC4UX, KC5UX, KC4UY, KC8UY, KC12UR, KC4UEW, KC8UCR-3, KC8UCR-4, KC8UCR-5, KC4FR-1, KC4FR-2, KC8UE, KC4UE (all the above, manufactured by Konica Minolta Opt. Inc.).

The polarizing film which is a main structural element of a polarizing plate is an element to allow only light with a given-direction-polarized wave face to pass through. The currently-know typical polarizing films are polyvinyl alcohol based polarizing films. The polyvinyl alcohol based polarizing films have two types in which the first type is a polyvinyl alcohol film dyed with iodine and the second type is a polyvinyl alcohol film dyed with dichroic die. However, the present invention is not limited these films.

The polarizing film is produced such that a polyvinyl alcohol aqueous solution is made to a film, the resulting film is stretched uniaxially and then dyed, or is dyed and then stretched uniaxially, and thereafter preferably subjected to durability treatment with a boron compound. The polarizing film has a thickness of 5 to 30 μm, and preferably 8 to 15 μm. One surface of the hard coat film according to the present invention is passed on a surface of the polarizing film, whereby a polarizing plate is produced. Preferably, the hard coat film is pasted with a water based adhesive containing a fully-saponified polyvinyl alcohol as a main component.

### <Adhesive Layer>

An adhesive layer provided on one surface of a protective film in order to be pasted to a substrate of a liquid crystal cell preferably has proper viscous elasticity and adherence characteristics as well as optically transparence.

By use of polymers of adhesive compounds or adhesive agents such as acrylic copolymer and epoxy system resin, polyurethane, silicone polymers, polyether, butyral resins, polyamide resins, polyvinyl alcohol resins, and synthetic rubber, a film is formed and cured by at least one of methods of drying, chemically curing, heat curing, heat melting, light curing, and the like, whereby an adhesive layer is formed. Among them, acrylic copolymer may be preferably employed, because of easiest in control of adhesive property and excellence in transparency, weather resistance, and durability.

### <Liquid Crystal Display>

Incorporation of a polarizing plate of the present invention produced by use of a hard coat film according to the present invention in a display device enables production of an image display apparatus excellent in various visibilities.

The hard coat film according to the present invention is assembled in a polarizing plate, and is preferably used in liquid crystal display devices of various drive systems, such as a reflection type, transmission type, or semi-transmission liquid crystal display device or in liquid crystal display devices with various drive systems, such as TN type, STN type, OCB type, HAN type, VA type (PVA type, MVA type), IPS type, and OCB type.

### EXAMPLE

Although the present invention will be concretely explained with reference to examples, the present invention is not limited to these examples. Unless otherwise specified, in examples, “%” and “parts” represent “% by weight” and “parts by weight”.

### Example 1

### <Cellulose Ester>

In this example, as the cellulose ester, materials shown in Table 1 were prepared.

TABLE 1

| | Degree of |
|---|---|
| | substitution |
| Cellulose ester | Acetyl group |
| A | 2.0 |
| B | 2.3 |
| C | 2.4 |
| D | 2.6 |
| E | 1.9 |
| F | 2.7 |
| G | 2.9 |

### <Production of a First Cellulose Ester Film (Substrate Film)>

### <Silicon Dioxide Dispersion Liquid>

| | |
|---|---|
| Aerosil 972 V manufactured by Japan Aerosil | 12 parts by weight |
| Co., Ltd. (average particle size of primary | |
| particles: 16 nm, apparent specific gravity: | |
| 90 g/litter) | |
| Ethanol | 88 parts by weight |

The above materials were stirred and mixed by a dissolver for 30 minutes, and then dispersed by Manton Gaulin. Into the resulting silicon dioxide dispersion liquid, 88 parts by weight of methylene chloride was added while being stirred, and further stirred and mixed for 30 minutes by a dissolver, thereby producing a silicon dioxide dispersion diluted liquid>

### (Production of an In-Line Additive Liquid)

| | | |
|---|---|---|
| TINUVIN 109 (manufactured by Basf | 11 | parts by weight |
| Japan Co., Ltd) | | |
| TINUVIN 171 (manufactured by Basf | 5 | parts by weight |
| Japan Co., Ltd) | | |
| Methylene chloride | 100 | parts by weight |

The above materials were put in a closed vessel, dissolved completely while being heated and stirred, and filtered.

Into the above liquid, 36 parts by weight of the silicon dioxide dispersion diluted liquid was added while being stirred, and further stirred for 30 minutes. Successively, 6 parts by weight of cellulose triacetate mentioned below was added while being stirred, and further stirred for 60 minutes. Subsequently, the resulting liquid was filtered by a polypropylene wound cartridge filter TCW-PPS-1 N manufactured by Advantec Toyo Kaisha, Ltd., thereby preparing an in-line additive liquid.

### (Preparation of a Dope Liquid)

| | | |
|---|---|---|
| Cellulose ester G | 100 | parts by weight |
| Trimethylolpropane tribenzoate | 5.0 | parts by weight |
| Ethylphthalyl ethyl glycolate | 5.5 | parts by weight |
| Methylene chloride | 440 | parts by weight |
| Ethanol | 40 | parts by weight |

The above materials were put in a closed vessel, dissolved completely while being heated and stirred, and filtered by use of Azumi filter paper No.244 manufactured by Azumi Filter Paper Co., Ltd., whereby the dope liquid was prepared.

The dope liquid was filtered in a film production line by use of Fine Met NF manufactured by Nippon Seisen Co., Ltd. Similarly, the in-line additive liquid was filtered in an in-line additive liquid line by use of Fine Met NF manufactured by Nippon Seisen Co., Ltd. To 100 parts by weight of the filtered dope liquid, 2 parts by weight of the filtered in-line additive liquid was added, and mixed sufficiently by an inline mixer (Toray static in-tube mixer Hi-Mixer SWJ). Subsequently, by use of a belt casting device, the resultant mixture solution was evenly cast on a stainless steel band support with a width of 1.8 m at a temperature of 35° C.

The solvent was evaporated on the stainless steel band support until the remaining solvent amount became 120%, and then the cast film was peeled from the stainless steel band support. The peeled cellulose ester web was heated to 35° C. so as to evaporate the solvent, was slit so as to have a width of 1.65 m, and thereafter was dried with a drying temperature of 135° C. while being stretched to 1.05 times in the TD direction (the direction perpendicular to the conveyance direction of the film) by a tenter. The remaining solvent amount at the time of start of stretching with the tenter was 30%.

Thereafter, the film was dried while being conveyed with many rollers in the drying zones of 110° C. and 120° C., was slit so as to have a width of 1.5 m, and was subjected to a knurling process applied to both edges of the film with a width of 15 mm and a height of 10 μm, whereby First cellulose ester film 1 with a thickness of 60 μm was produced.

As a result of measurement of the retardation value, Ro and Rt were 3 nm and 50 nm respectively.

### <Production of a Hard Coat Film 1>

The following hard coat layer coating composition 1-1 was filtered via a filter made from polypropylene with a pore size of 0.4 μm, thereby preparing a hard coat layer coating liquid. Then, the hard coat layer coating liquid was coated on the above-produced first cellulose ester film 1 by use of a micro gravure coater. Successively, the coating layer was dried at 80° C., and then irradiated with ultraviolet rays by use of a ultraviolet ray lamp with an illuminance of 80 mW/cm² and an irradiation amount of 80 mJ/m² at an irradiating section so as to cure the coating layer, whereby a hard coat layer 1 with a dry film thickness of 9 μm was formed. Continuously, on the hard coat layer 1, a hard coat layer coating composition 1-2 was coated by an extrusion coater, and the resulting coating layer was dried at 80° C. Successively, while being subjected to a nitrogen purge so as to form an atmosphere with an oxygen concentration of 1.0 volume % or less, the dried coating layer was irradiated with ultraviolet rays by use of a ultraviolet ray lamp with an illuminance of 150 mW/cm² and an irradiation amount of 250 mJ/cm² at an irradiating section so as to cure the coating layer, whereby a hard coat layer 2 l with a dry film thickness of 0.6 μm was formed. Then, the thus-laminated film was wound up, thereby producing a roll-shaped hard coat film 1.

### (A Hard Coat Layer Coating Composition 1-1)

The following materials were stirred and mixed, thereby preparing a hard coat layer coating composition 1-1.

| | | |
|---|---|---|
| Pentaerythritol triacrylate | 55 | parts by weight |
| Pentaerythritol tetraacrylate | 55 | parts by weight |
| Irgacure 184 (manufactured by BASF | 5.0 | parts by weight |
| Japan Co. Ltd., photopolymerization | | |
| initiator) | | |
| Polyether-modified silicone (KF354L: | 2.0 | parts by weight |
| manufactured by Shin-Etsu Chemical | | |
| Co, Ltd.) | | |
| Propylene glycol monomethyl ether | 10 | parts by weight |
| Methyl acetate | 60 | parts by weight |
| Methyl ethyl ketone | 70 | parts by weight |

### (A Hard Coat Layer Coating Composition 1-2)

The following materials were stirred and mixed, thereby preparing a hard coat layer coating composition 1-2.

| A thermoplastic resin, a polyester urethane resin | 6 | parts by weigh |
|---|---|---|
| (Trade Name “Byran UR1350”: manufactured | (2.0 parts by weight | |
| by Toyobo Co., Ltd., solid content concentration: | as a polyester | |
| 33% (toluene methyl ethyl ketone solvent = | urethane resin) | |
| 65/35)) | | |
| Pentaerythritol triacrylate | 30 | parts by weight |
| Pentaerythritol tetraacrylate | 30 | parts by weight |
| Irgacure 184 (manufactured by BASF Japan | 3.0 | parts by weight |
| Co. Ltd., photopolymerization initiator) | | |
| Irgacure 907 (manufactured by BASF Japan | 1.0 | parts by weight |
| Co. Ltd., photopolymerization initiator) | | |
| Polyether-modified polydimethyl siloxane | 2.0 | parts by weight |
| (BYK-UV3510: manufactured by BYK Japan | | |
| KK) | | |
| Propylene glycol monomethyl ether | 150 | parts by weight |
| Methyl ethyl ketone | 150 | parts by weight |

### <Production of Hard Coat Films 2 to 12>

Hard coat films 2 to 12 were produced in the same way as that in the hard coat film 1 except that the polyester urethane resin (thermoplastic resin) in the hard coat layer coating composition 1-2 in the production of the hard coat film 1 was changed to the resins and the added amount (parts by weight) shown in Table 3. In this connection, in the addition of the polyester urethane resin (“Byran UR1350”, solid content concentration: 33%), the added amount of Propylene glycol monomethyl ether was adjusted in accordance with the added amount of the polyester urethane resin such that the amount of solvent became a fixed amount.

### <Production of a Hard Coat Film 13>

A hard coat film 13 was produced in the same way as that in the hard coat film 1 except that a hard coat layer 2 was not provided, and the dried coating layer of the hard coat film 1 was irradiated with ultraviolet rays by use of a ultraviolet ray lamp with an illuminance of 150 mW/cm² and an irradiation amount of 250 mJ/cm² at an irradiating section so as to cure the coating layer while being subjected to a nitrogen purge so as to form an atmosphere with an oxygen concentration of 1.0 volume % or less.

### <Production of a Hard Coat Film 14>

A hard coat film 14 was produced in the same way as that in the hard coat film 1 except that a hard coat layer 2 was not provided, the coating composition of the coating layer 1 was changed to a hard coat layer coating composition 14-1, and the coating layer of the hard coat film 1 was irradiated with ultraviolet rays by use of a ultraviolet ray lamp with an illuminance of 150 mW/cm² and an irradiation amount of 250 mJ/cm² at an irradiating section so as to cure the coating layer while being subjected to a nitrogen purge so as to form an atmosphere with an oxygen concentration of 1.0 volume % or less.

### (A Hard Coat Layer Coating Composition 14-1)

The following materials were stirred and mixed, thereby preparing a hard coat layer coating composition 14-1.

| | | |
|---|---|---|
| A thermoplastic resin, a polyester resin | 8 | parts by weight |
| (Trade Name “Byran 220”: manufactured | | |
| by Toyobo Co., Ltd.) | | |
| Pentaerythritol triacrylate | 55 | parts by weight |
| Pentaerythritol tetraacrylate | 55 | parts by weight |
| Irgacure 184 (manufactured by BASF | 5.0 | parts by weight |
| Japan Co. Ltd., photopolymerization | | |
| initiator | | |
| Irgacure 907 (manufactured by BASF | 1.0 | parts by weight |
| Japan Co. Ltd., photopolymerization | | |
| initiator) | | |
| Polyether-modified silicone (KF354L: | 2.0 | parts by weight |
| manufactured by Shin-Etsu Chemical | | |
| Co, Ltd.) | | |
| Propylene glycol monomethyl ether | 10 | parts by weight |
| Methyl acetate | 60 | parts by weight |
| Methyl ethyl ketone | 70 | parts by weight |

### <Production of a Hard Coat Film 15>

A hard coat film 15 was produced in the same way as that in the hard coat film 14 except that the added amount of thermoplastic resin (a polyester resin (Trade Name “Byran 220”: manufactured by Toyobo Co., Ltd.) was changed to 16 parts by weight

### <Production of a Hard Coat Film 16>

A hard coat film 16 was produced in the same way as that in the hard coat film 1 except that the hard coat layer 2 was not provided, the hard coat layer coating composition 1-1 was coated on the first cellulose ester film 1, and dried. Thereafter, the coating layer was embossed with a mold roll produced with reference to example in Japanese Unexamined Patent Publication No. 2008-276198 (in the used mold roll, a patter was arranged regularly). Subsequently, while being subjected to a nitrogen purge so as to form an atmosphere with an oxygen concentration of 1.0 volume % or less, the dried coating layer was irradiated with ultraviolet rays by use of a ultraviolet ray lamp with an illuminance of 150 mW/cm² and an irradiation amount of 250 mJ/cm² at an irradiating section so as to cure the coating layer, whereby a hard coat layer 1 with a dry film thickness of 9 μm was formed.

### <Production of a Hard Coat Film 17>

A hard coat film 17 was produced in the same way as that in the hard coat film 16 except that the configuration of the patter on the mold roll was changed.

### <Production of a Second Cellulose Ester Film 101 (Protective Film)>

The cellulose esters changed in terms of the degree of substitution as shown in Table 1 were used

### <Particle Dispersion Liquid>

| | |
|---|---|
| Particles (Aerosil 812 manufactured by Japan | 11 parts by weight |
| Aerosil) (average particle size of primary | |
| particles: 16 nm, apparent specific gravity: | |
| 90 g/litter) | |
| Ethanol | 89 parts by weight |

The substances materials were stirred and mixed by a dissolver for 50 minutes and then dispersed by Manton Gaulin.

### <Particle Additive Liquid>

Cellulose ester A was added into a solution tank storing methylene chloride, heated and dissolved completely. Thereafter the resultant solution was filtered by the use of Azumi filter paper No. 244 manufactured by Azumi Filter Paper Co., Ltd. While the filtered cellulose ester solution was fully being agitated, particulate dispersion liquid was added slowly into the solution. Furthermore, the solution was dispersed by an attritor so that the particle size of secondary particles became a predetermined size. The resultant solution was filtered by the use of Fine Met NF manufactured by Nippon Seisen Co., Ltd., whereby particulate additive liquid was prepared.

| | | |
|---|---|---|
| Methylene chloride | 99 | parts by weight |
| Cellulose ester B | 4 | parts by weight |
| Particulate dispersion liquid 1 | 11 | parts by weight |

A main dope liquid of the following composition was prepared. First, methylene chloride and ethanol were added to a pressure solution tank. Cellulose ester B was supplied into the pressure solution tank storing a solvent while being agitated. Further, it was dissolved completely while being heated and agitated. The resultant liquid was filtered by the use of Azumi filter paper No. 244 manufactured by Azumi Filter Paper Co., Ltd., whereby the main dope liquid was prepared.

Into 100 parts by weight of the main dope solution, 5 parts by weight of the particulate additive liquid was added, and then sufficiently mixed by an inline mixer (Toray static in-line mixer Hi-Mixer SWJ). Then, by the use of a belt casting device, the resultant mixture solution was evenly cast with a width of 2.0 m on a stainless steel band support.

The solvent was evaporated on the stainless steel band support until the remaining solvent amount became 110%, and then the cast film was peeled from the stainless steel band support. At the time of peeling, the web (peeled film) was stretched with tension such that a longitudinal stretching ratio (MD) became 1.1 times. Subsequently, the web was further stretched by a tenter grasping the both ends of the web such that a stretching ratio in the width (TD) direction became 13 times. After the stretching, the web was held for several seconds while the width of the web was maintained with tension, then the tension in the width direction was relaxed, and successively, the maintaining of the width was released. Subsequently, the web was dried by being conveyed in a third drying zone set as 125° C. for 30 minutes, whereby the second cellulose ester film 101 which had a width of 1.5 m, a thickness of 50 μm, and embosses at both ends with a width of 1 cm and a height of 8 μm was produced.

### <Composition of Main Dope>

| | | |
|---|---|---|
| Methylene chloride | 390 | parts by weight |
| Ethanol | 80 | parts by weight |
| Cellulose ester C | 100 | parts by weight |
| Plasticizer: ester compound, Compound 4 | 10 | parts by weight |
| Plasticizer: Aromatic terminal ester type | 2.5 | parts by weight |
| plasticizer (1) | | |

The second cellulose ester films 102 to 106 were produced in the same way as with the above second cellulose ester film 101 except that the composition (cellulose ester) of the dope liquid was changed as shown in Table 2.

The resulting second cellulose ester films 101 to 106 were subjected to measurement of an in-plane retardation value R0 and a thickness direction retardation value Rt, and the measurement results are shown in Table 2.

### (Measurement of Retardation Value Ro and Rt)

Ro=(nx−ny)×d

Rt={(nx+ny)/2−nz)×d

(in the formula, nx, ny, and nz represent respectively a refractive index in main axis directions x, y, and z in an index ellipsolid, and nx and ny represent a film in-plane refractive index, and nz is a refractive index in the film thickness direction. Further, nx and ny are in a relationship of nx>ny, and d is a thickness (nm) of a film.)

With an Abbe refraction index meter (1T) equipped with an eye piece with a polarizing plate and a spectrum light source, a refraction index was measured in one direction, the direction perpendicular to the one direction, and the direction vertical to the film surface on both surfaces of a retardation film, and an average refraction index is determined from the average value of these measurements. Further, the thickness of the film was measured using a commercially-available micrometer.

Films were left uncontrolled for 24 hours under the environment of 23° C. and 55% RH, and thereafter retardation of the films were measured by the use of an automatic birefringence analyzer (KOBRA-21ADH manufactured by Oji Scientific Instruments) under the above environment with a wavelength of 590 nm. The above-mentioned refraction index and the thickness were input into the above formulas, hereby determining an in-plane retardation value (Ro) and a thickness direction retardation value (Rt).

### <Production of a Polarizing Plate 201>

### (Alkali Saponification Treatment)

One sheet of the hard coat film 1 and one sheet of the second cellulose ester film 101 were used as protective films for a polarizing film, thereby producing a polarizing plate 201.

(a) Production of a Polarizing Film

Into 100 parts by weight of polyvinyl alcohol (hereafter, abbreviated as PVA) having a degree of saponification being 99.95 mol % and a degree of polymerization being 2400, a composition impregnated with 100 parts by weight of glycerin and 170 parts by weight of water was dissolved, kneaded and was subjected to a defoaming process. Subsequently, the resultant liquid was extruded on a metal roll from a T die so as to form a film. Then, the film was dried and subjected to a heat treatment, whereby a PVA film was obtained.

The thus obtained PVA film has an average thickness of 40 μm, a moisture percentage of 4.4% and a film width of 3 m. Subsequently, the above PVA film was continuously subjected to the following processes in the order of preliminary swelling, dyeing, uniaxial stretching by a wet method, fixing treatment, drying, and heat treatment, whereby a polarization film was produced. The preliminary swelling was conducted in such a way that the PVA film was dipped in water at 30° C. for 30 seconds. Then, the PVA film was dipped in an aqueous solution having an iodine concentration of 0.4 g/liter and a potassium iodide concentration of 40 g/liter at 35° C. for 3 minutes. Subsequently, the film was uniaxially stretched to 6 times in an aqueous solution having a boric acid concentration of 4% at 50° C. under the condition that a tension applied to the film was 700 N/m. Then, the fixing process was conducted in such a way that the film was dipped in an aqueous solution having a potassium iodide concentration of 40 g/liter, a boric acid concentration of 40 g/liter and a zinc chloride concentration of 10 g/liter at 30° C. for 5 minutes. Thereafter, the PVA film was taken out, dried with hot air of 40° C., and further subjected to a heat treatment at 100° C. for 5 minutes. The thus obtained polarizing film had an average thickness of 13 μm and, as a polarizing performance, a transmittance of 43.0%, a polarization degree of 993% and a dichroic ratio of 40.1.

(b) Production of a Polarizing Plate

Next, in accordance with the following processes of 1 through 5, the polarizing film, the second cellulose ester film 101, and the hard coat film 1 were pasted, thereby producing a polarizing plate 201.

### Process 1:

The above-mentioned polarizing film was immersed in a storage tank of a polyvinyl alcohol adhesive solution with a solid content of 2 weight % for 1 to 2 seconds.

### Process 2:

The second cellulose ester film 101 and the hard coat film 1 in which a protective film (made of PET) with peel property was pasted on a hard coat layer were subjected to alkali saponification treatment on the following conditions. Successively, excessive adhesive agent adhering on the polarizing film at the time of immersion in the polyvinyl alcohol adhesive solution at Process 1 was removed lightly, and then polarizing film was sandwiched between the second cellulose ester film 101 and the hard coat film 1 so as to form a laminated film structure shown in FIG. 2.

### (Alkali Saponification Treatment)

| | | | |
|---|---|---|---|
| Saponification process | 1.5M-KOH | 50° C. | 45 seconds |
| Washing process | Water | 30° C. | 60 seconds |
| Neutralization process | 10 parts | 30° C. | 45 seconds |
| | by weight HCl | | |
| Washing process | Water | 30° C. | 60 seconds |

The saponification process, washing process, neutralization process, and washing process were performed in this order, followed by drying at 100° C.

### Process 3:

The laminated films were pasted by two rotating rollers with a pressure of from 20 to 30 N/cm² at a speed of about 2 m/minute. At this time, this process was conducted with a care that no air bubble enters.

### Process 4:

The laminated film sample produced in Process 3 was dried at 80° C. in a dryer for 5 minutes, whereby a polarizing plate was produced.

### Process 5:

A commercially-available acrylic adhesive was coated on the second cellulose film 101 (protective film) of the polarizing plate produced at Process 4 such that a dried layer thickness became 25 μm, and dried with an oven with a temperature of 110° C. for 5 minutes so as to form an adhesive layer, and then, the protective film with peel property was pasted on the adhesive layer. The resulting polarizing plate was cut into (punching) a size of 576×324 mm, thereby producing a polarizing plate 201.

### <Production of Polarizing Plates 202 to 217>

Polarizing plates 202 to 217 were produced in the same way as that in the polarizing plate 201 except that the hard coat film 1 was changed to hard coat films 2 to 17.

### <Production of a Liquid Crystal Display 401>

The built-in polarizing plate of the liquid crystal panel of a SONY 40 type display KDL-40V5 was removed, and the above-produced polarizing plate 201 (refer to FIG. 2 with regard to the structure) was installed as the polarizing plate at the viewing side in place of the remove built-in polarizing plate such that the hard coat layer was placed at the viewing side, and the adhesive layer was pasted on the liquid crystal cell glass. Further, at the back light side, a polarizing plate, in which the first cellulose film 1 subjected to the alkali saponification treatment in the same way as the above-mentioned procedure was pasted so as to sandwich the polarizing film in the laminated film structure, was pasted on a liquid crystal cell glass by use of an acrylic adhesive agent with a thickness of 25 μm, thereby producing a liquid crystal panel 301. Next, the liquid crystal panel 301 was set to a liquid crystal television, thereby producing a liquid crystal display 401.

### <Production of Liquid Crystal Displays 402 to 417>

Liquid crystal displays 402 to 417 were produced in the same way as that in the liquid crystal display 401 except that the polarizing plate 201 was replaced with the polarizing plates 202 to 217.

### <<Evaluation>>

The following evaluation was performed for the above-produced hard coat films 1 to 17, polarizing plates 201 to 217, and image display devices 401 to 417.

### (Hard Coat Film)

a. Measurement of Surface Roughness (Ra)

The respective hard coat layers of the above-produced hard coat films 1 to 17 was subjected to measurement by 10 times by use of an optical interference type surface roughness meter (RST/PLUS: manufacture by WYKO Co.), and the surface roughness (Ra) of each hard coat film was calculated from the average of the measurement results. The obtained results are shown in Table 3.

b. Measurement of the Number of Protrusions

The number of protrusion-shaped configurations was counted at the time of measurement of the above-mentioned surface roughness (Ra) (number per 0.01 mm² of the measurement area). Next, the number of protrusions on the hard coat layer of each hard coat film was determined from average of ten counted-measurements. In this connection, protrusions with a height of 3 nm or more from the average line in a roughness curve were counted as the number of protrusions. The obtained results are shown in Table 3.

c. Measurement of Haze

The first cellulose ester film (substrate film) and each of the above-produced hard coat films were subjected to measured of haze by use of a haze meter (NDH2000: manufactured by Nippon Denshoku Industries Co., Ltd.) in accordance with JIS-K7136. In this connection, the haze value of the first cellulose ester film (substrate film) was 0.28%. The haze value of each of the above hard coat films is shown in Table 3.

### (Polarizing Plate)

a. Endurance Test

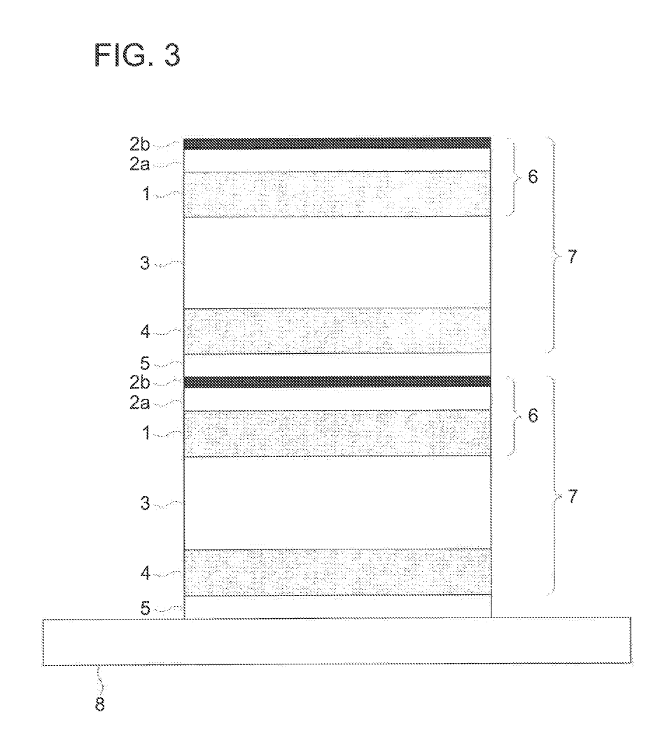

After the protective film with a peel property on the hard coat layer of each of the polarizing plates 201 to 218 was peeled, the polarizing plates were stacked by 500 sheets shown in FIG. 3, and then, the lowermost polarizing plate was further pasted on a glass plate across a adhesive layer and preserved for 240 hours on the condition of 80° C. and 90%.

b. Observation of Deformation Failure

The polarizing plates being subjected to the above-mentioned endurance test were observed from the hard coat layer side, and the status of deformation failure was evaluated based on the following criterion.

A: Deformation failure was not observed at all.

B: Although deformation failure was observed at few parts, there was no problem for actual use.

C: Deformation failure was observed on some parts, and there was problem for actual use.

D: The occurrence of partial deformation failure was acknowledged clearly with the observation from a distance.

### (Liquid Crystal Display)

### a (Streak Evaluation)

In order to check deterioration by heat for the above-prepared liquid crystal display devices 401 to 417, the liquid crystal display devices were subjected processing for 300 hours on the conditions of 60° C., and thereafter, were returned to the condition of 23° C. and 55% RH. Subsequently, at two hours after the power source switch was put in service to turn on the back light, streaks at the time of the black indication mode was visually checked and evaluated based on the following criteria.

A: no streak

B: Weak streaks existed at the central potion.

C: Weak streaks existed from the central potion to the edge portions.

D: Strong streaks existed on the entire surface.

Streaks with the rank of A or B are evaluated as no problem for practical use.

### b <<Evaluation of Visibility>>

The above-produced liquid crystal display devices were left uncontrolled for 100 hours on the conditions of 60° C. and 90% RH, and thereafter, returned to the condition of 23° C. and 55% RH. Subsequently, the surfaces of the respective liquid crystal display devices were visually observed and evaluated based on the following criteria

A: No wavy unevenness was observed on the surface.

B: Wavy unevenness was slightly observed on the surface.

C: Fine wavy unevenness was slightly observed on the surface.

D: Fine wavy unevenness was observed on the surface.

The above evaluation results are shown in Table 4.

The specific trade names of the thermoplastic resins described in Table 3 are as follows.
Polyester resin: Trade name “Byran 220”, manufactured by Toyobo Co., Ltd.
Hydroxyl group-containing acrylic polymer: Trade name “UH-2000”, manufactured by Toagosei Co., Ltd.
Carboxyl group-containing acrylic polymer. Trade name “UC-3000”, manufactured by Toagosei Co., Ltd.

As can be understood from the results shown in Table 3, the polarizing plate of the present invention in which the hard coat layer of a hard coat film includes thermoplastic resin selected from thermoplastic polyester resin, thermoplastic polyester urethane resin, and acrylic resin not having an ethylenically-unsaturated double bond; the hard coat layer has the numbers of protrusions within a range of 500 to 200,000 pieces per mm²; and the hard coat film has a haze value of 0.3 to 0.7%, exhibits performances excellent in both prevention of deformation failure at the time of store under high temperature and high humidity and streak at the time of use for a liquid crystal display device and visibility (clearness).

Among the polarizing plates according to the present invention, the polarizing plate of the present invention having a hard coat layer with an arithmetic average roughness Ra of 3 to 20 nm exhibits specifically excellent effects to prevent modification failure.

Incidentally, the hard coat film and polarizing plate according to the present invention were subjected to the pencil hardness test in which the respective test samples were placed for 12 hours in a humidity-controlled state of 23° C., 55% RH by use of a test pencil specified in JIS-S6006 and a weight of 500 g in accordance with a pencil hardness evaluation method specified in JIS-K5400. As a result, each of the hard coat film and polarizing plate according to the present invention has 2 H or more.

### Example 2

### <Production of Polarizing Plates 219 to 229>

Polarizing plates 219 to 229 were produced in the same way as that in the polarizing plate 201 except that the second cellulose film and the hard coat were changed as shown in Table 4.

### <Production of Liquid Crystal Displays 419 to 429>

Liquid crystal displays 419 to 429 were produced in the same way as that in the liquid crystal display 401 except that the polarizing plate 201 was replaced with the polarizing plates 219 to 229.

### <<Evaluation>>

The polarizing plates 219 to 229 were evaluated in the endurance test similarly to the endurance test of the polarizing plate of Embodiment 1 except that the preservation time was changed to 480 hours. Further, the polarizing plates 201 and 219 to 229 and the liquid crystal displays 401 and 419 to 429 were evaluated in terms of streaks in the same way in Embodiment I except that the processing time was changed from 300 hours to 500 hours, and in terms of visibility in the same way in Embodiment 1 except that the leaving time was changed from 100 hours to 150 hours.

As the measuring method of moisture vapor permeability, applicable is a method described in “Measurement of an amount of permeation steam (a weight method, a thermometer method, a vapor pressure method, an adsorption amount method) on pages 285 to 294 in “Physical properties of high molecule 11” (High molecule experiment lecture 4: by Kyoritsu publication Co., Ltd.). In this specification, the moisture vapor permeability was measured at a temperature of 40° C. and a humidity of 90% RH in accordance with JIS Standard: JISZ0208, B condition.

In the measurement of elastic modulus, a sample was subjected to humidity control for 24 hours under an environment of 25° C. and 60% RH, and thereafter, the elastic modulus of the sample was measured in accordance with a method described in JIS K7127. As a tension testing machine, used was Tension manufactured by ORIENTEC Co., Ltd. The tension test was conducted on the conditions that a test piece was made in a size of 100 mm×10 mm, a distance between chucks was 50 mm, and a test rate was 100 mm/minute.

The results obtained by the above measurements are collectively shown in Tables 2 to 4.

TABLE 2

| | | | | | Elastic |
|---|---|---|---|---|---|
| | | | | | modulus ratio |
| | | | | | Conveyance |
| Second | Kind of | Retardation | | Water vapor | direction (MD)/ |
| cellulose | cellulose | value nm | | permeability | width direction |
| ester film | ester | Ro | Rth | g/m² · day | (TD) |
| 101 | C | 50 | 130 | 1150 | 0.85 |
| 102 | A | 60 | 140 | 1500 | 0.75 |
| 103 | B | 55 | 135 | 1320 | 1.0 |
| 104 | D | 50 | 130 | 1000 | 1.3 |
| 105 | E | 60 | 145 | 1650 | 0.7 |
| 106 | F | 20 | 65 | 920 | 1.35 |

TABLE 3

| Polarizing plate | | | | | | | | | | | | |
|---|---|---|---|---|---|---|---|---|---|---|---|---|
| | | Hard coat film | | | | | | | | | | |
| | | | | The | | Hard | | Evaluation | | | | |
| | | | | number of | | coat layer 1 | | Polariz- | | | | |
| | | | | protrusions | | Thermoplastic | Hard coat layer 2 | ing | Liquid Crystal display | | | |
| | | | Ra | (pieces per | Haze | resin (parts by | Thermoplastic resin (parts by | plate | | Visibil- | | |
| No. | *1 | No. | (nm) | mm²) | value | weight) | weight) | *2 | No. | ity | Streak | Remarks |
| 201 | 101 | 1 | 12 | 120000 | 0.42 | — | Polyester urethane resin (2.0) | A | 401 | A | A | Inv. |
| 202 | 101 | 2 | 9 | 100000 | 0.42 | — | Polyester resin (2.0) | A | 402 | A | A | Inv. |
| 203 | 101 | 3 | 3 | 62000 | 0.33 | — | Hydroxyl group-containing acrylic | A | 403 | A | A | Inv. |
| | | | | | | | resin (2.0) | | | | | |
| 204 | 101 | 4 | 3 | 58000 | 0.31 | — | Carboxyl group-containing acrylic | A | 404 | A | A | Inv. |
| | | | | | | | resin (2.0) | | | | | |
| 205 | 101 | 5 | 19 | 200000 | 0.55 | — | Polyester urethane resin (4.0) | A | 405 | A | A | Inv. |
| 206 | 101 | 6 | 17 | 190000 | 0.51 | — | Polyester resin (4.0) | A | 406 | A | A | Inv. |
| 207 | 101 | 7 | 11 | 105000 | 0.49 | — | Hydroxyl group-containing acrylic | A | 407 | A | A | Inv. |
| | | | | | | | resin (6.0) | | | | | |
| 208 | 101 | 8 | 10 | 100000 | 0.44 | — | Carboxyl group-containing acrylic | A | 408 | A | A | Inv. |
| 209 | 101 | 9 | 2 | 600 | 0.35 | — | Hydroxyl group-containing acrylic | B | 409 | B | B | Inv. |
| | | | | | | | resin (0.2) | | | | | |
| 210 | 101 | 10 | 2 | 550 | 0.32 | — | Carboxyl group-containing acrylic | B | 410 | B | B | Inv. |
| | | | | | | | resin (0.2) | | | | | |
| 211 | 101 | 11 | 26 | 260000 | 0.89 | — | Polyester urethane resin (14.0) | B | 411 | D | D | Comp. |
| 212 | 101 | 12 | 21 | 210000 | 0.91 | — | Hydroxyl group-containing acrylic | B | 412 | D | D | Comp. |
| | | | | | | | resin (16.0) | | | | | |
| 213 | 101 | 13 | 0.5 | 0 | 0.33 | — | — | D | 413 | B | B | Comp. |
| 214 | 101 | 14 | 16 | 160000 | 0.61 | Polyester resin | — | B | 414 | B | B | Inv. |
| | | | | | | (8.0) | | | | | | |
| 215 | 101 | 15 | 22 | 220000 | 0.72 | Polyester resin | — | B | 415 | D | D | Comp. |
| | | | | | | (16.0) | | | | | | |
| 216 | 101 | 16 | 1 | 5000 | 0.31 | — | — | D | 416 | C | C | Comp. |
| 217 | 101 | 17 | 28 | 230000 | 0.84 | — | — | B | 417 | D | D | Comp. |

*1: Second cellulose ester film,
*2: Observation of deformation failure,
Inv.: Inventive,
Comp.: Comparative

TABLE 4

| Polarizing plate | | | | | | | | | | | |
|---|---|---|---|---|---|---|---|---|---|---|---|
| | | Hard coat film | | | | | | | | | |
| | | | | | Hard coat layer 1 | | Evaluation | | | | |
| | | | The number of | | Thermoplastic | Hard coat layer 2 | Polarizing | | | | |
| | | | protrusions | Haze | resin (parts by | Thermoplastic resin (parts by | plate | Liquid Crystal display | | | |
| No. | *1 | No. | (pieces per mm²) | value | weight) | weight) | *2 | No. | Visibility | Streak | Remarks |
| 201 | 101 | 1 | 120000 | 0.42 | — | Polyester urethane resin (2.0) | A | 401 | A | A | Inv. |
| 219 | 102 | 1 | 120000 | 0.41 | — | Polyester urethane resin (2.0) | A | 419 | B | B | Inv. |
| 220 | 103 | 1 | 120000 | 0.38 | — | Polyester urethane resin (2.0) | A | 420 | A | A | Inv. |
| 221 | 104 | 1 | 120000 | 0.45 | — | Polyester urethane resin (2.0) | B | 421 | B | B | Inv. |
| 222 | 105 | 1 | 120000 | 0.71 | — | Polyester urethane resin (2.0) | A | 422 | D | D | Comp. |
| 223 | 106 | 1 | 120000 | 0.73 | — | Polyester urethane resin (2.0) | D | 423 | D | B | Comp. |
| 224 | 101 | 14 | 160000 | 0.61 | Polyester resin | — | A | 424 | A | A | Inv. |
| | | | | | (8.0) | | | | | | |
| 225 | 102 | 14 | 160000 | 0.68 | Polyester resin | — | B | 425 | B | B | Inv. |
| | | | | | (8.0) | | | | | | |
| 226 | 103 | 14 | 160000 | 0.58 | Polyester resin | — | A | 426 | B | B | Inv. |
| | | | | | (8.0) | | | | | | |
| 227 | 104 | 14 | 160000 | 0.68 | Polyester | — | B | 427 | B | B | Inv. |
| | | | | | resin(8.0) | | | | | | |
| 228 | 105 | 14 | 160000 | 0.88 | Polyester resin | — | B | 428 | D | D | Comp. |
| | | | | | (8.0) | | | | | | |
| 229 | 106 | 14 | 160000 | 0.86 | Polyester resin | — | D | 429 | D | C | Comp. |
| | | | | | (8.0) | | | | | | |

*1: Second cellulose ester film,
*2: Observation of deformation failure,
Inv.: Inventive,
Comp.: Comparative

As can be understood from the results shown in Tables 2 to 4, in the more severe tests, by use of a film with a moisture vapor permeability of 1000 g/m²•day or more and 1500 g/m²•day or less, elastic modulus: 0.75 MD/TD 1.3, and a degree of substitution with an acetyl group being 2.0 to 2.6 as the second cellulose ester film, it becomes possible to obtain effects excellent in prevention of modification failure and good visibility at the time of application in a liquid crystal display device.

Incidentally, the above-mentioned embodiment for carrying out the invention may be summarized to the following preferable structure from an another aspect of the present invention.
1. A polarizing plate in which a second cellulose ester film (protective film), a polarizing film, and a hard coat film having a hard coat layer on a first cellulose ester film (substrate film) are laminated in this order, is characterized in that (1) the hard coat layer has protrusions with the numbers of protrusions within a range of 500 to 200,000 the number of pieces per mm² and the hard coat layer includes resin selected from thermoplastic polyester resin, thermoplastic polyester urethane resin, and acrylic resin not having an ethylenic unsaturated double bond, and (2) the second cellulose ester film has a retardation value Ro represented by the following Formula (I) in a range of 40 to 100 nm, a retardation value Rth represented by the following Formula (II) in a range of 90 to 300 nm, water vapor permeability in a range of 1000 to 1,500 g/m²•day, and a ratio of elastic modulus in a conveyance direction to elastic modulus in a direction perpendicular to the conveyance direction satisfying the following Formula (III).

Ro=(nx−ny)×d Formula (I):

Rth={(nx+ny)/2−nz}×d Formula (II):

0.75≦conveyance direction (MD)/perpendicular direction (TD)≦1.3 Formula (III):

(in the formulas, nx represents a refractive index in the in-plane slow axis direction of the film, ny represents a refractive index in the in-plane fast axis direction of the film, nz represents a refractive index in the thickness direction of the film, and d is the thickness (nm) of the film).
2. The polarizing plate described in the item 1 is characterized in that the hard coat layer has a arithmetic average roughness (JIS B0601: 2001) being in a range of 3 to 20 nm.
3. The polarizing plate described in the item 1 or 2 is characterized in that the second cellulose ester film has a degree of substitution with an acetyl group being in a rage of 2.0 to 2.6.
4. The polarizing plate described in any one of the items 1 to 3 is characterized in that the first cellulose ester film has a degree of substitution with an acetyl group being in a rage of 2.8 to 3.0.
5. The polarizing plate described in any one of the items 1 to 4 is characterized in that the second cellulose ester film contains an ester compound which includes 1 to 12 pieces of at least one of a pyranose structure or a furanose structure in which all or a part of hydroxyl groups (OH group) in the structure are esterified.
6. A liquid crystal display device is characterized by comprising the polarizing plate described in any one of the items 1 to 5 on at least one of a liquid crystal cell.

What is claimed is;:

1. A polarizing plate, comprising:
a hard coat film;
a protective film; and
a polarizer sandwiched between the hard coat film and the protective film,
wherein the hard coat film includes a first cellulose ester film being contact with the polarizer, and a hard coat layer provided on the first cellulose ester film,
wherein the hard coat layer includes a composition containing a curable resin and at least one thermoplastic resin selected from a group of a thermoplastic polyester resin, a thermoplastic polyester urethane resin, and an acrylic resin not having an ethylenically-unsaturated double bond, and
wherein the hard coat layer is a cured layer of the composition, and has 500 to 200,000 protrusions per mm² on a surface thereof.

2. The polarizing plate described in claim 1, wherein the curable resin is an actinic ray curable resin.

3. The polarizing plate described in claim 1, wherein a ratio by weight between the curable resin and the thermoplastic resin is in a range of (100:0.01) to (100:10).

4. The polarizing plate described in claim 1, wherein each of the protrusions has a height of 1 nm to 5 μm.

5. The polarizing plate described in claim 1, wherein the hard coat layer has an arithmetic average toughness Ra of 3 to 20 nm according to HS B0601: 2001.

6. The polarizing plate described in claim 1, wherein the hard coat layer has a pencil hardness of 1 H or more.

7. The polarizing plate described in claim 1, wherein the first cellulose ester film has a degree of substitution of 2.8 to 3.0 with an acetyl group.

8. The polarizing plate described in claim 1, wherein the hard coat layer includes a plurality of layers, and an uppermost layer of the plurality of layers is the cured layer of the composition containing the thermoplastic resin and the curable resin.

9. The polarizing plate describe: in claim 8, wherein the uppermost layer has a thickness of 0.05 to 2 μm.

10. The polarizing plate described in claim 1, wherein the proactive film includes a second cellulose ester film, and the second cellulose ester film has a retardation value Ro represented by Formula (I) in a range of 40 to 100 nm, and a retardation value Rth represented by Formula (II) in a range of 90 to 300 nm,
Ro=(nx−ny)×d Formula (I):
Rth={(nx+ny)/2−nz}×d Formula (II):
in the formulas, nx represents a refractive index in an in-plane slow axis direction of the film, ny represents a refractive index in an in-plane, fast axis direction of the film, nz represents a refractive index in a thickness direction of the film, and d is a thickness (nm) of the film.

11. The polarizing plate described in claim 1, wherein the second cellulose ester film has a water vapor permeability in a range of 1000 to 1,500 g/m²•day.

12. The polarizing plate described in claim 1, wherein the second cellulose ester film has a ratio of elastic modulus (MD) to elastic modulus (TD) Which satisfies Formula (III).
0.75≦MD/TD≦1.3 Formula (III):
where MD represents elastic modulus in a conveyance direction, and ID represents elastic modulus in a direction perpendicular to the conveyance direction.

13. The polarizing plate described in claim 1, wherein the second cellulose ester film has a degree of substitution of 2.0 to 2.6 with an acetyl group.

14. The polarizing plate described in claim 1, wherein the second cellulose ester film contains an ester compound which includes 1 to 12 pieces of at least one of a pyranose structure or a furanose structure in which all or a pad of hydroxyl groups are esterified.
